(19) United States
(12) Patent Application Publication
(10) Pub. No.: US 2006/0176606 A1
(43) Pub. Date: Aug. 10, 2006

(54) Magnetic recording medium, recording/reproducing apparatus, and stamper

(75) Inventors: Yoshikazu Soeno, Tokyo (JP); Takahiro Suwa, Tokyo (JP)

Correspondence Address: GREENBLUM & BERNSTEIN, P.L.C., 1950 ROLAND CLARKE PLACE, RESTON, VA, 20191, US

(73) Assignee: TDK Corporation, Tokyo (JP)

(21) Appl. No.: 11/345,514

(22) Filed: Feb. 2, 2006

(30) Foreign Application Priority Data
Feb. 4, 2005 (JP) 2005-028853

(51) Int. Cl. G11B 5/596; G11B 5/09

(52) U.S. Cl. 360/77.08; 360/48

(57) ABSTRACT

A servo pattern is formed in a servo pattern region on at least one surface of a substrate of a magnetic recording medium by a concave/convex pattern including a plurality of convex parts, at least protruding end parts of which are formed of magnetic material, and at least one concave part. The servo pattern region includes an address pattern region and a burst pattern region. The at least one concave part is formed in the servo pattern region so that a larger of an inscribed circle with a largest diameter out of inscribed circles on protruding end surfaces of the convex parts formed in the address pattern region and an inscribed circle with a largest diameter out of inscribed circles on protruding end surfaces of the convex parts formed in the burst pattern region is an inscribed circle with a largest diameter out of inscribed circles on protruding end surfaces of the convex parts formed in the servo pattern region.

### BACKGROUND OF THE INVENTION

1. Field of the Invention

The present invention relates to a magnetic recording medium where a servo pattern is formed by a concave/convex pattern in a servo pattern region, a recording/reproducing apparatus equipped with the magnetic recording medium, and a stamper for manufacturing the magnetic recording medium.

2. Description of the Related Art

As one example of a recording/reproducing apparatus equipped with this kind of magnetic recording medium, a magnetic recording apparatus equipped with a discrete track-type magnetic disk is disclosed by Japanese Laid-Open Patent Publication No. H09-097419. The magnetic disk provided in the magnetic recording apparatus is constructed by forming concentric recording tracks (“belt-shaped convex parts”) of a recording magnetic material (“magnetic material”) on one surface of a glass disk substrate (“substrate”) so that various kinds of data can be recorded and reproduced. Guard band parts are also formed by filling concave parts between the respective recording tracks with a guard band material (a non-magnetic material) to make the magnetic disk smoother and to magnetically separate adjacent magnetic tracks.

When manufacturing such magnetic disk, first a magnetic material is sputtered onto one surface of the substrate to form the recording magnetic layer. Next, after a positive-type resist has been spin-coated so as to cover the recording magnetic layer and prebaked, the same pattern as the guard band parts is drawn using a matrix cutting apparatus and then developed. By doing so, a resist pattern (concave/convex pattern) is formed on the recording magnetic layer. After this, the recording magnetic layer is etched using the resist pattern as a mask and mask residue on the magnetic recording layer is then removed by an ashing apparatus. By doing so, recording tracks composed of magnetic material and servo patterns (concave/convex patterns where the convex parts are formed of the magnetic material) are formed on the substrate. After this, a non-magnetic material is sputtered onto the substrate in this state. When doing so, the non-magnetic material is sputtered sufficiently thickly to completely fill the concave parts that compose the servo pattern and the concave parts between the recording tracks with the non-magnetic material and to cover the recording tracks and the convex parts that compose the servo patterns with the non-magnetic material. Next, the surface of the sputtered non-magnetic material is dry-etched to expose the protruding end surfaces (the surface of the magnetic material) of the convex parts that compose the servo patterns, the recording tracks, and the like from the non-magnetic material. By doing so, the magnetic disk is completed.

### SUMMARY OF THE INVENTION

By investigating the conventional magnetic disk described above, the present inventors discovered the following problem. With the conventional magnetic disk, after the non-magnetic material is sputtered so as to cover the entire substrate, the non-magnetic material is dry-etched until the protruding end surfaces (upper surfaces) of the convex parts composing the servo patterns, the recording tracks, and the like are exposed, thereby smoothing the surface. However, when a magnetic disk is manufactured according to this method of manufacturing, when dry etching is carried out, there are cases where a large amount of non-magnetic material (hereinafter, non-magnetic material remaining on the convex parts is also referred to as “residue”) remains on the convex parts with wide protruding end surfaces (for example, “long” convex parts where both the length in the direction of rotation of the magnetic disk and the length in the radial direction are long), resulting in the convex parts being thickly covered with residue.

A specific example is shown in FIG. 32. A magnetic disk 10z manufactured according to the method of manufacturing described above is manufactured by setting data recording regions Atz, in which data track patterns 40tz respectively composed of a plurality of concentric data recording tracks are formed, and servo pattern regions 40Asz, in which servo patterns 40sz for tracking servo purposes are formed, so as to alternate in the direction of rotation (the direction of the arrow R in FIG. 32) of the magnetic disk 10z. Here, as shown in FIG. 33, a servo pattern region Asz of the magnetic disk 10z includes for example a preamble pattern region Apz in which a preamble pattern is formed, an address pattern region Aaz in which an address pattern is formed, and a burst pattern region Abz where burst patterns are formed in the burst regions Ab1z to Ab4z. Here, non-servo signal regions Axz constructed of convex parts composed of magnetic material (a magnetic layer 14) are formed in the respective regions located between a data recording region Atz and the preamble pattern region Apz, between the preamble pattern region Apz and the address pattern region Aaz, between the address pattern region Aaz and the burst pattern region Abz, and between the burst pattern region Abz and the next data recording region Atz. In addition, non-servo signal regions Axbz constructed of convex parts composed of a magnetic material (the magnetic layer 14) are formed in the regions between the respective burst regions Ab1z to Ab4z in the burst pattern region Abz. Here, control signals for tracking servo control are not recorded in the non-servo signal regions Axz, Axbz and the non-servo signal regions Axz, Axbz are entirely constructed of the convex parts described above with no concave parts being present. Note that the obliquely shaded areas in FIG. 33 represent the formation regions of the convex parts (the convex parts 40az in FIG. 34) in the servo pattern 40sz and the data track pattern 40tz.

Here, the present inventors discovered a phenomenon whereby when dry etching is carried out on the layer of non-magnetic material 15 (a layer of material for forming guard band parts between the respective convex parts 40az and the like: see FIG. 34) formed so as to cover the servo patterns 40sz and the like to expose the convex parts 40az, the wider the protruding end surfaces of the convex parts 40az present below the layer of material (for example, the greater both the length along the direction of rotation of the magnetic disk 10z and the length along the radial direction of the protruding end surfaces of the convex parts 40az), the slower the etching of the non-magnetic material 15 proceeds. Accordingly, in the non-servo signal regions Axz, Axbz and the like where convex parts with wide protruding end surfaces are formed, thick residue is produced by the dry etching process on the layer of the non-magnetic material 15. More specifically, as shown in FIG. 34, the non-magnetic material 15 is sufficiently etched by dry etching on the convex parts 40az where the length L11 of the protruding end surfaces along the direction of rotation is short, for example, exposing the protruding end surfaces of the convex parts 40az from the non-magnetic material 15. On the other hand, since the etching of the non-magnetic material 15 proceeds slowly on the convex parts 40az where the protruding end surfaces are excessively wide, if the dry etching is terminated at a point where the protruding end surfaces of the convex parts 40az whose length L11 is short are exposed from the non-magnetic material 15, this results in a state where the residue with the thickness T is produced (a state where the convex parts 40az are covered by the non-magnetic material 15). As a result, at positions where the residue is produced (the non-servo signal regions Axz, Axbz and the like), there is deterioration in surface smoothness inside the servo pattern regions Asz.

On the other hand, if dry etching is carried out until the residue is completely removed from the convex parts 40az whose protruding end surfaces are excessively wide, at the positions of the convex parts 40az where the lengths L11 of the protruding end surfaces along the direction of rotation are short, not only the non-magnetic material 15 but also the magnetic layer 14 (the convex parts 40az themselves) is etched. Accordingly, when the dry etching continues until the residue on the convex parts 40az is completely removed across the entire range of the servo pattern regions Asz including the non-servo signal regions Axz, Axbz, there is the risk of excessively etching the convex parts 40az in the concave/convex patterns inside the preamble pattern regions Apz and the concave/convex patterns inside the address pattern regions Aaz where the lengths along the direction of rotation and the lengths along the radial direction of the protruding end surfaces are comparatively short, which can make it difficult to read magnetic signals reliably.

The present invention was conceived in view of the problem described above, and it is a principal object of the present invention to provide a magnetic recording medium including servo patterns from which a magnetic signal can be reliably read and which have favorable surface smoothness, a recording/reproducing apparatus, and a stamper that can manufacture such magnetic recording medium.

On a magnetic recording medium according to the present invention, a servo pattern is formed in a servo pattern region on at least one surface of a substrate by a concave/convex pattern including a plurality of convex parts, at least protruding end parts of which are formed of magnetic material, and at least one concave part, and the servo pattern region includes an address pattern region and a burst pattern region, wherein the at least one concave part is formed in the servo pattern region so that a larger of an inscribed circle (an inscribed circle of a planar form on a protruding end surface of a convex part) with a largest diameter out of inscribed circles on protruding end surfaces of the convex parts formed in the address pattern region and an inscribed circle with a largest diameter out of inscribed circles on protruding end surfaces of the convex parts formed in the burst pattern region is an inscribed circle with a largest diameter out of inscribed circles on protruding end surfaces of the convex parts formed in the servo pattern region.

On the above magnetic recording medium, by forming the at least one concave part in the servo pattern region so that a larger of an inscribed circle with a largest diameter out of inscribed circles on protruding end surfaces of the convex parts formed in the address pattern region and an inscribed circle with a largest diameter out of inscribed circles on protruding end surfaces of the convex parts formed in the burst pattern region is an inscribed circle with a largest diameter out of inscribed circles on protruding end surfaces of the convex parts formed in the servo pattern region, since no convex parts with wide protruding end surfaces that can have an inscribed circle with a diameter that exceeds the diameter of the larger inscribed circle are present inside the servo pattern region, when the layer of non-magnetic material formed so as to cover the concave/convex pattern inside the servo pattern region is etched, a situation where thick residue remains on the convex parts is avoided. By doing so, it is possible to provide a magnetic recording medium which has favorable smoothness inside the servo pattern region and from which servo data can be reliably read.

Also, on the above magnetic recording medium, a plurality of data recording tracks may be formed in a data recording region on the at least one surface of the substrate by the convex parts, at least protruding end parts of which are formed of the magnetic material, and the data recording tracks may be formed so that a length along a radial direction is equal to or smaller than the diameter of the larger of the inscribed circles.

By doing so, it is possible to avoid a situation where thick residue is produced on the convex parts inside the data recording region. Accordingly, it is possible to provide a magnetic recording medium which has favorable smoothness in both the servo pattern region and the data recording region (i.e., across the entire magnetic recording medium) and is capable of stabilized recording and reproducing.

A recording/reproducing apparatus according to the present invention includes either of the magnetic recording media described above and a control unit that carries out a tracking servo control process based on a predetermined signal read from the servo pattern region of the magnetic recording medium.

According to the above recording/reproducing apparatus, it is possible to record and reproduce data via a magnetic head that is made on-track to the convex parts (a data recording track) inside the data recording region without being affected by the presence of the concave/convex patterns (dummy patterns) formed in the regions aside from the region in which control signals for tracking servo control are recorded.

On another magnetic recording medium according to the present invention, a servo pattern is formed in a servo pattern region on at least one surface of a substrate by a concave/convex pattern including a plurality of convex parts, at least protruding end parts of which are formed of magnetic material, and at least one concave part, wherein the servo pattern region includes a plurality of types of first function regions in which a control signal for tracking servo control is recorded by the concave/convex pattern during manufacturing and a second function region where a concave/convex pattern of a different type to the concave/convex patterns of the first function regions is formed.

According to this other magnetic recording medium, by constructing the servo pattern region so as to include a plurality of types of first function regions in which a control signal for tracking servo control is recorded by a concave/convex pattern during manufacturing and a second function region where a concave/convex pattern of a different type to the concave/convex patterns of the first function regions is formed, unlike the conventional magnetic disk 10z where the entire non-servo signal regions Axz, Axbz are composed of convex parts, it is possible to avoid a situation where residue remains inside the second function regions, and even if residue is produced, such residue can be made sufficiently thin.

In addition, on the other magnetic recording medium described above, the servo pattern region may include an address pattern region and a burst pattern region as types in the plurality of types of first function regions, wherein the at least one concave part may be formed in the second function region so that a diameter of an inscribed circle with a largest diameter out of inscribed circles on protruding end surfaces on convex parts formed in the second function region is equal to or smaller than a diameter of a larger of an inscribed circle with a largest diameter out of inscribed circles on protruding end surfaces of the convex parts formed in the address pattern region and an inscribed circle with a largest diameter out of inscribed circles on protruding end surfaces of the convex parts formed in the burst pattern region.

According to the other magnetic recording medium described above, it is possible to avoid a situation where thick residue is produced inside the second function region.

On yet another magnetic recording medium according to the present invention, a servo pattern is formed in a servo pattern region on at least one surface of a substrate by a concave/convex pattern including a plurality of convex parts, at least protruding end parts of which are formed of magnetic material, and at least one concave part, wherein the servo pattern region includes a plurality of types of first function regions in which a control signal for tracking servo control is recorded by the concave/convex pattern during manufacturing and a second function region formed entirely of the at least one concave part.

According to the yet other magnetic recording medium described above, by constructing the servo pattern region so as to include a plurality of types of first function regions in which a control signal for tracking servo control is recorded by a concave/convex pattern during manufacturing and a second function region formed entirely of the at least one concave part, since convex parts for which there is the risk of residue being produced are not present in the second function regions and excessively wide protruding end surfaces (convex parts for which concave parts are not present within a predetermined range) are not present at positions aside from the second function regions, when etching the layer of non-magnetic material formed so as to cover the concave/convex pattern inside the servo pattern region, it is possible to avoid a situation where thick residue is produced on the convex parts across the entire servo pattern region including the second function regions. By doing so, it is possible to provide a magnetic recording medium which has favorable smoothness inside the servo pattern region and from which the servo data can be read reliably.

Another recording/reproducing apparatus according to the present invention includes either the other magnetic recording medium or the yet other magnetic recording medium described above and a control unit that carries out a tracking servo control process based on a predetermined signal read from the first function regions of the magnetic recording medium.

According to the above recording/reproducing apparatus, it is possible to record and reproduce data via a magnetic head that is made on-track to the convex parts (a data recording track) inside the data recording region without being affected by the presence of the concave/convex patterns (dummy patterns) formed in the second function regions.

A stamper according to the present invention is used for manufacturing a magnetic recording medium, and on such stamper is formed a concave/convex pattern including at least one convex part formed corresponding to the at least one concave part in the concave/convex pattern of any of the magnetic recording media described above and a plurality of concave parts formed corresponding to the respective convex parts in the concave/convex pattern of the magnetic recording medium.

On this stamper, by forming a concave/convex pattern including at least one convex part formed corresponding to the at least one concave part in the concave/convex pattern on any of the magnetic recording media described above and a plurality of concave parts formed corresponding to the respective convex parts in the concave/convex pattern of such magnetic recording medium, when carrying out imprinting on a preform for manufacturing a magnetic recording medium, for example, it is possible to avoid a situation where convex parts with excessively wide protruding end surfaces that can have an inscribed circle with a larger diameter than an inscribed circle with a largest diameter out of inscribed circles on protruding end surfaces of the convex parts formed in the address pattern region or the burst pattern region are formed in the servo pattern region. This means that by etching the preform using the concave/convex pattern as a mask, it is possible to avoid a situation where convex parts with wide protruding end surfaces that can have an inscribed circle with a larger diameter than the inscribed circle with the largest diameter described above are formed inside the servo pattern region. Accordingly, when etching the layer of non-magnetic material formed so as to cover the concave/convex pattern, it is possible to avoid a situation where thick residue is produced on the convex parts inside the servo pattern region. By doing so, it is possible to manufacture a magnetic recording medium which has favorable smoothness and from which servo data can be read reliably. Also, since no concave parts that are excessively wide are present on the stamper corresponding to the protruding end surfaces of the convex parts of the magnetic recording medium, when the concave/convex pattern of the stamper is pressed onto a resin layer of a preform (a layer for forming a concave/convex pattern by imprinting), it is possible to avoid a situation where the convex parts are insufficiently high (i.e., the resin mask is insufficiently thick) due to an insufficient amount of resin material (the resin layer) moving into the concave parts of the stamper. Accordingly, when the preform is etched with the concave/convex pattern formed on the preform as a mask, it is possible to avoid a situation where the convex parts used as the mask disappear before the etching of the preform is complete, and as a result, it is possible to form a concave/convex pattern with at least one sufficiently deep concave part in the preform.

It should be noted that the disclosure of the present invention relates to a content of Japanese Patent Application 2005-028853 that was filed on 4 Feb. 2005 and the entire content of which is herein incorporated by reference.

### BRIEF DESCRIPTION OF THE DRAWINGS

These and other objects and features of the present invention will be explained in more detail below with reference to the attached drawings, wherein:

FIG. 1 is a diagram showing the construction of a hard disk drive;

FIG. 2 is a plan view of a magnetic disk shown in FIG. 1;

FIG. 3 is a plan view of principal parts of the magnetic disk shown in FIG. 2 showing examples of various patterns formed in a data recording region and a servo pattern region in an outer periphery region;

FIG. 4 is a cross-sectional view showing the layer construction of the magnetic disk shown in FIG. 1;

FIG. 5 is a plan view of a data recording region showing one example of a data track pattern formed in the data recording region shown in FIG. 3;

FIG. 6 is a plan view of a preamble pattern region showing one example of a preamble pattern formed in the preamble pattern region shown in FIG. 3;

FIG. 7 is a plan view of an address pattern region showing one example of an address pattern formed in the address pattern region shown in FIG. 3;

FIG. 8 is a plan view of a burst pattern region showing one example of burst patterns formed in a first burst region and a second burst region shown in FIG. 3;

FIG. 9 is a plan view of a burst pattern region showing one example of burst patterns formed in a third burst region and a fourth burst region shown in FIG. 3;

FIG. 10 is a plan view of a non-servo signal region showing one example of a concave/convex pattern formed in a non-servo signal region shown in FIG. 3;

FIG. 11 is a plan view of a non-servo signal region showing one example of a concave/convex pattern formed in a non-servo signal region shown in FIG. 3;

FIG. 12 is a cross-sectional view showing the multilayer structure of a preform;

FIG. 13 is a cross-sectional view of a stamper;

FIG. 14 is a cross-sectional view of a state where a resist layer has been formed on a glass substrate;

FIG. 15 is a cross-sectional view of a state where latent images have been formed by emitting an electron beam onto a resist layer;

FIG. 16 is a cross-sectional view of a state where a concave/convex pattern is formed by carrying out a developing process on the resist layer in which the latent images have been formed;

FIG. 17 is a cross-sectional view of a state where a nickel layer is formed so as to cover the concave/convex pattern;

FIG. 18 is a cross-sectional view of a state where a nickel layer is formed by a plating process;

FIG. 19 is a cross-sectional view of a stamper formed by separating the laminated body of the nickel layers from the glass substrate;

FIG. 20 is a cross-sectional view of a state where a nickel layer is formed on a surface of a stamper on which a concave/convex pattern is formed (a state where the concave/convex pattern has been transferred to the nickel layer);

FIG. 21 is a cross-sectional view of a state where a concave/convex pattern of the stamper is pressed onto a resin layer of the preform;

FIG. 22 is a cross-sectional view of a state where the stamper has been separated from the resin layer in the state shown in FIG. 21 to form a concave/convex pattern (a resin mask) on a mask layer;

FIG. 23 is a cross-sectional view of a state where the mask layer has been etched with the concave/convex pattern as a mask to form a concave/convex pattern (mask) on the magnetic layer;

FIG. 24 is a cross-sectional view of a state where the magnetic layer has been etched with the concave/convex pattern as a mask to form a concave/convex pattern on an intermediate layer;

FIG. 25 is a cross-sectional view of the preform in a state where a layer of the non-magnetic material is formed to cover the concave/convex pattern;

FIG. 26 is a plan view of a magnetic disk showing another example of various patterns formed in a data recording region and a servo pattern region in an outer periphery region;

FIG. 27 is a plan view of a burst pattern showing one example of a burst pattern formed in the burst pattern region of the servo pattern region shown in FIG. 26;

FIG. 28 is a plan view of an address pattern showing one example of an address pattern formed in the address pattern region of the servo pattern region shown in FIG. 26;

FIG. 29 is a cross-sectional view showing the multilayer structure of another magnetic disk;

FIG. 30 is a cross-sectional view showing the multilayer structure of yet another magnetic disk;

FIG. 31 is a plan view of another magnetic disk showing examples of various patterns formed in a data recording region and a servo pattern region in an outer periphery region;

FIG. 32 is a plan view of a conventional magnetic disk;

FIG. 33 is a plan view of the conventional magnetic disk showing one example of various patterns formed in a data recording region and a servo pattern region; and

FIG. 34 is a cross-sectional view showing the multilayer structure of the conventional magnetic disk.

### DESCRIPTION OF THE PREFERRED EMBODIMENTS

Preferred embodiments of a magnetic recording medium, a recording/reproducing apparatus, and a stamper according to the present invention will now be described with reference to the attached drawings.

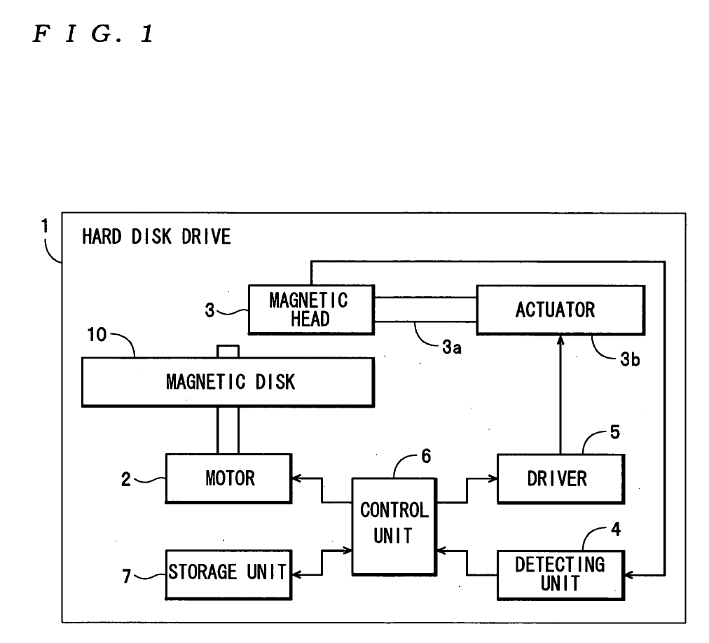

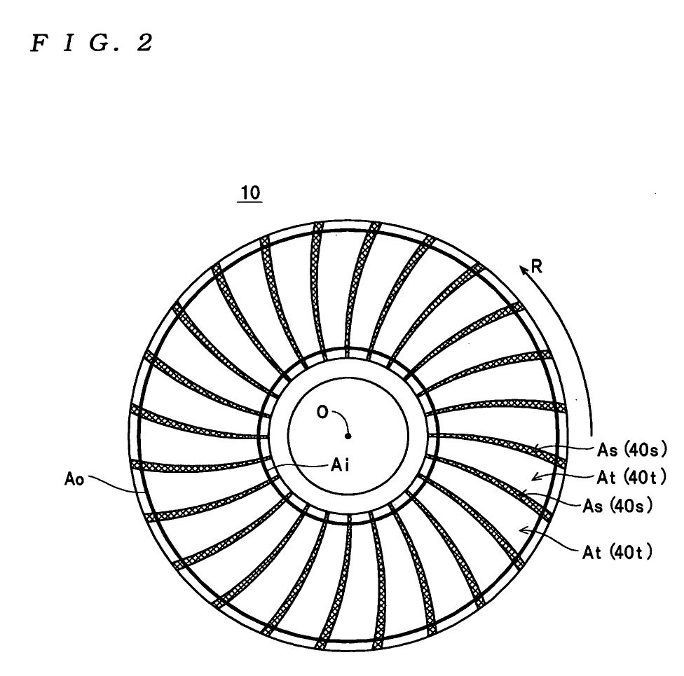

A hard disk drive 1 shown in FIG. 1 is one example of a recording/reproducing apparatus according to the present invention and includes a motor 2, a magnetic head 3, a detecting unit 4, a driver 5, a control unit 6, a storage unit 7, and a magnetic disk 10 so as to be capable of recording and reproducing various kinds of data. According to control by the control unit 6, the motor 2 rotates the magnetic disk 10 at a fixed speed, for example, 4200 rpm. The magnetic head 3 is attached to an actuator 3b via a swing arm 3a and is caused to move above the magnetic disk 10 by the actuator 3b during the recording and reproducing of data on the magnetic disk 10. Also, the magnetic head 3 carries out the reading of servo data from a servo pattern region As of the magnetic disk 10 (see FIG. 2), the magnetic writing of data in a data recording region At (see FIG. 2), and the reading of recording data that has been magnetically written in the data recording region At. Note that although the magnetic head 3 is actually formed on a base surface (air bearing surface) of a slider to cause the magnetic head 3 to fly above the magnetic disk 10, the slider has been omitted from the description and the drawings. By swinging the swing arm 3a using a driving current supplied from the driver 5 under the control of the control unit 6, the actuator 3b moves the magnetic head 3 to an arbitrary recording/reproducing position on the magnetic disk 10.

The detecting unit 4 obtains (detects) servo data from an output signal (analog signal) outputted from the magnetic head 3 and outputs the servo data to the control unit 6. The driver 5 controls the actuator 3b in accordance with a control signal outputted from the control unit 6 to make the magnetic head 3 on-track to a desired data recording track. The control unit 6 carries out overall control over the hard disk drive 1. The control unit 6 is one example of a “control unit” for the present invention and controls the driver 5 (i.e., executes a tracking servo control process) based on the servo data (one example of a “predetermined signal read from the servo pattern region”) outputted from the detecting unit 4. The storage unit 7 stores an operation program of the control unit 6 and the like.

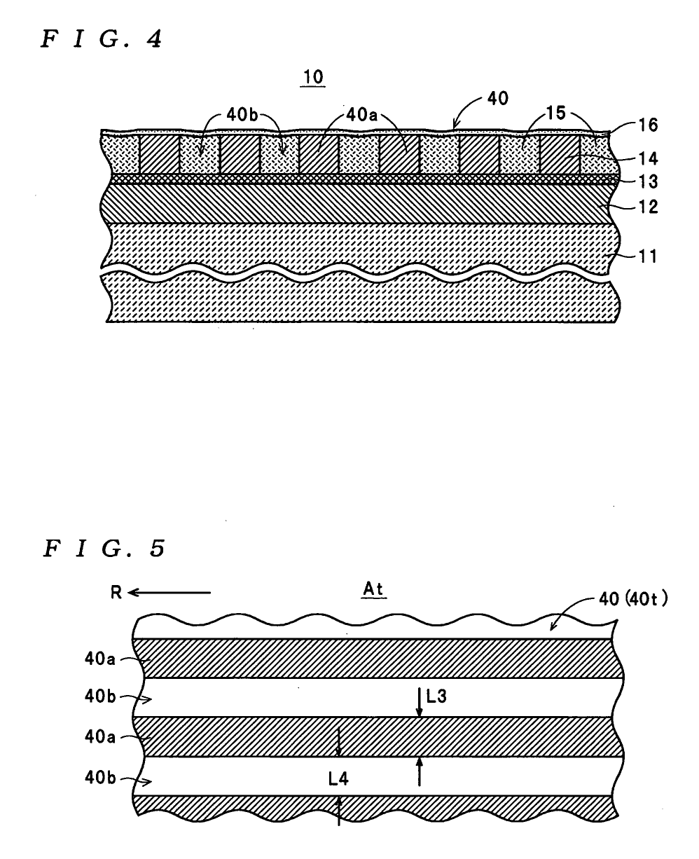

On the other hand, the magnetic disk 10 is one example of the magnetic recording medium according to the present invention, and is installed inside a case of the hard disk drive 1 together with the motor 2, the magnetic head 3, and the like described above. The magnetic disk 10 is a discrete track-type magnetic disk (a patterned medium) on which data can be recorded using a perpendicular recording method, and as shown in FIG. 4, a soft magnetic layer 12, an intermediate layer 13, and a magnetic layer 14 are formed in the mentioned order on a glass substrate 11. Here, the magnetic layer 14 constructs a concave/convex pattern 40 in which are formed convex parts 40a, which are entirely formed of magnetic material from protruding end parts (the upper end parts in FIG. 4) thereof to base end parts (the lower end parts in FIG. 4), and concave parts 40b located between the convex parts 40a. Also, the concave parts 40b are filled with non-magnetic material 15 such as SiO₂ to smooth the surface of the magnetic disk 10. In addition, a protective layer 16 (a DLC film) with a thickness of around 2 nm is formed using diamond-like carbon (DLC) on the surfaces of the non-magnetic material 15 filled in the concave parts 40b and the magnetic layer 14 (the convex parts 40a). A lubricant (as one example, a Fomblin lubricant) is also applied onto the surface of the protective layer 16 of the magnetic disk 10a to prevent damage to both the magnetic head 3 and the magnetic disk 10.

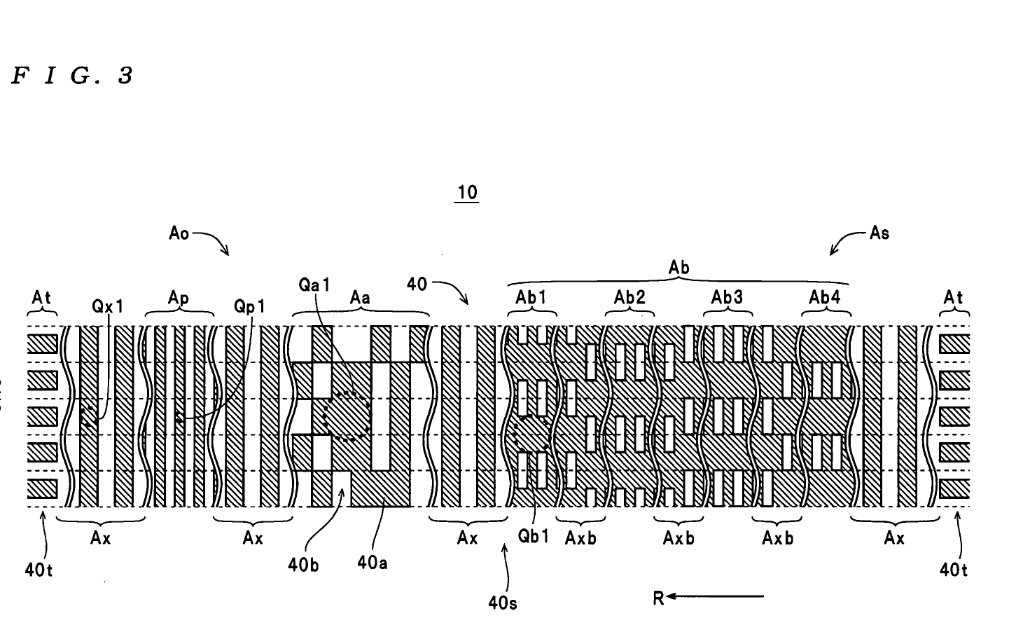

The glass substrate 11 corresponds to a “substrate” for the present invention and is formed in a disk-like shape with a thickness of around 0.6 mm by polishing the surface of a glass plate. Note that the substrate for the present invention is not limited to a glass substrate and it is possible to use a substrate formed in a disk-like shape using various types of non-magnetic material such as aluminum and ceramics. The soft magnetic layer 12 is formed as a thin film with a thickness of around 100 nm to 200 nm by sputtering a soft magnetic material such as CoZrNb alloy. The intermediate layer 13 functions as an underlayer for forming the magnetic layer 14 and is formed as a thin film with a thickness of around 40 nm by sputtering an intermediate layer forming material such as Cr or a non-magnetic CoCr alloy. The magnetic layer 14 is a layer that constructs the concave/convex pattern 40 (the data track patterns 40t and the servo patterns 40s shown in FIG. 3) and as described later, the concave parts 40b are formed by etching a layer produced by sputtering CoCrPt alloy, for example.

Here, as shown in FIG. 2, on the magnetic disk 10, the servo pattern regions As are provided between the data recording regions At and are set so that the data recording region At and the servo pattern region As are alternately disposed in the direction of rotation of the magnetic disk 10 (i.e., the direction of the arrow R). Note that in the present specification, each region sandwiched by two data recording regions At disposed in the direction of rotation (each region from a trailing end in the direction of rotation of a data recording region At to a leading end in the direction of rotation of another data recording region At) is regarded as a servo pattern region As. Also, the ends in the direction of rotation of the data recording regions At are set as coinciding with virtual segments (straight or arc-like segments along the radial direction of the magnetic disk 10) that join the respective ends in the direction of rotation of a plurality of data recording tracks (the convex parts 40a described later) formed in the data recording region At.

The hard disk drive 1 equipped with the magnetic disk 10 is constructed so that the magnetic disk 10 is rotated at a fixed angular speed by the motor 2 in accordance with control by the control unit 6 as described above. Accordingly, on the magnetic disk 10, the length of each data recording region At along the direction of rotation of the magnetic disk 10 and the length of each servo pattern region As along the direction of rotation are set so as to increase as the distance from the center O increases in proportion to the length of a part of the magnetic disk 10 that passes below the magnetic head 3 per unit time (i.e., the data recording regions At and the servo pattern regions As are set so as to widen from an inner periphery region Ai toward an outer periphery region Ao). As a result, the length along the direction of rotation of the protruding end surfaces of the data recording tracks (the convex parts 40a) formed inside the data recording regions At and the standard lengths (for example, a length corresponding to a 1-bit signal length) along the direction of rotation of the protruding end surfaces of the convex parts 40a and the base surfaces of the concave parts 40b in the servo pattern 40s formed inside the servo pattern regions As are set so as to increase from the inner periphery region Ai toward the outer periphery region Ao of the magnetic disk 10.

Note that the standard length along the direction of rotation of the protruding end surfaces of the convex parts 40a inside the servo pattern regions As is set at a substantially equal length inside regions of several tens of tracks that are adjacent in the radial direction of the magnetic disk 10. For this reason, in the present specification, the case where the standard length along the direction of rotation is equal in such regions of several tens of tracks is described. More specifically, as examples, the standard lengths along the direction of rotation are equal inside regions of several tens of tracks included in the inner periphery region Ai and the standard lengths along the direction of rotation are equal inside regions of several tens of tracks included in the outer periphery region Ao. Also, if not specifically stated otherwise when describing the length along the direction of rotation of the protruding end surfaces of the convex parts 40a formed in the servo pattern regions As, corresponding lengths at positions with an equal radius (inside regions with an equal radius) where the distance from the center of the magnetic disk 10 is equal are described as standards.

Also, as shown in FIG. 3, a data track pattern 40t is formed in each data recording region At. Note that the obliquely shaded regions in FIG. 3 and FIGS. 5 to 11, 26 to 28, and 31 described later show formation regions of the convex parts 40a in the concave/convex patterns 40. Here, as shown in FIG. 5, the data track patterns 40t are composed of a large number of convex parts 40a (data recording tracks) that are concentric with the center O (see FIG. 2), and the concave parts 40b present between the respective convex parts 40a (“inter-track concave parts” corresponding to guard band parts on the conventional magnetic disk). Note that although it is preferable for the center of rotation of the magnetic disk 10 and the center O of the data track patterns 40t to match, there is the risk of a minute displacement of around 30 to 50 μm being caused between the center of rotation of the magnetic disk 10 and the center O of the data track patterns 40t due to manufacturing error. However, since tracking servo control can still be performed sufficiently for the magnetic head 3 when a displacement of such magnitude is present, the center of rotation and the center O can be thought of as effectively matching.

Also, as shown in FIG. 5, in each data recording region At of the magnetic disk 10, as one example the length L3 of the protruding end surfaces of the convex parts 40a (the data recording tracks) along the radial direction of the magnetic disk 10 is equal to the length L4 of the base surfaces of the concave parts 40b (the guard band parts) along the radial direction of the magnetic disk 10. That is, the ratio of the lengths is 1:1. In addition, on the magnetic disk 10, the length L3 along the radial direction of the magnetic disk 10 of the convex parts 40a formed in the data recording regions At and the length L4 along the radial direction of the concave parts 40b are set equal from the inner periphery region Ai to the outer periphery region Ao. Also, the concave parts 40b of the data track patterns 40t are filled with the non-magnetic material 15 to smooth the surface of the data recording regions At.

On the other hand, as shown in FIG. 3, a servo pattern 40s, which includes a preamble pattern formed in a preamble pattern region Ap, an address pattern formed in an address pattern region Aa, burst patterns formed in the burst pattern region Ab, and dummy patterns formed in non-servo signal regions Ax, is formed in each servo pattern region As. Here, the preamble pattern region Ap, the address pattern region Aa, and the burst pattern region Ab correspond to “first function regions” for the present invention, and the servo pattern 40s formed in such regions is a pattern corresponding to “a control signal for tracking servo control” for the present invention. Also, out of the servo patterns 40s, in the preamble pattern, the address pattern, and the burst patterns (that is, the patterns aside from the dummy patterns), the formation positions and sizes (lengths along the direction of rotation of the magnetic disk 10 and the like) of the convex parts 40a and concave parts 40b are set corresponding to “control signals for tracking servo control” for the present invention.

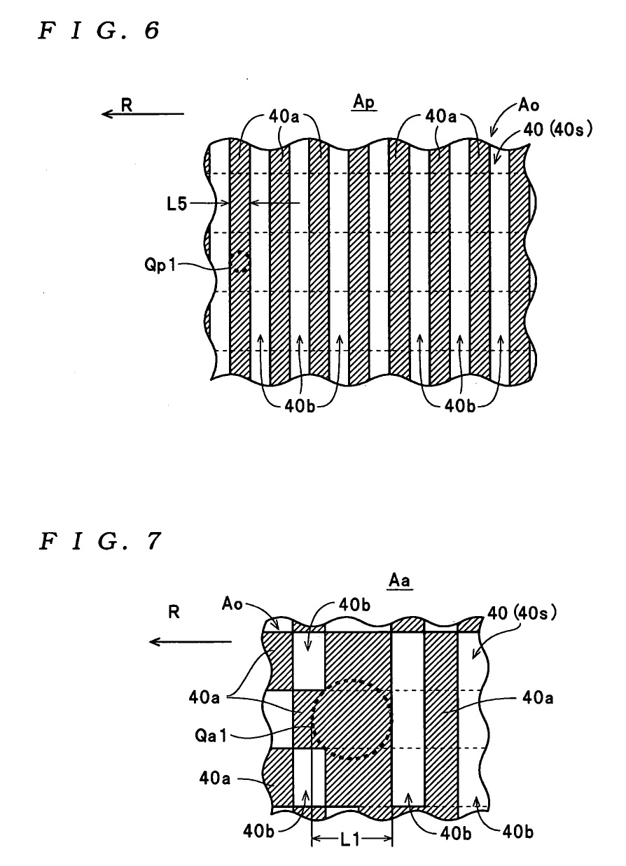

More specifically, the preamble pattern formed in the preamble pattern region Ap is a servo pattern for correcting a standard clock for reading various types of control signal from the address pattern region Aa and the like in accordance with the rotational state (rotation speed) of the magnetic disk 10, and as shown in FIG. 6, belt-shaped convex parts 40a that extend in the radial direction (the up-down direction in FIG. 6) of the magnetic disk 10 are formed along the direction of rotation (the direction of the arrow R) of the magnetic disk 10 with concave parts 40b in between. Here, the lengths along the direction of rotation of the protruding end surfaces of the convex parts 40a and the lengths along the direction of rotation of the base surfaces of the concave parts 40b formed in the preamble pattern region Ap are set equal at positions with the same radius where the distance from the center O is the same and so as to increase from the inner periphery region Ai toward the outer periphery region Ao.

Here, as one example, the lengths along the direction of rotation of the protruding end surfaces of the convex parts 40a formed in the preamble pattern region Ap in the outer periphery region Ao are set at one half of the length L3 along the radial direction of the protruding end surfaces of the convex parts 40a (the data recording tracks) formed in the data recording region At. Note that the lengths along the direction of rotation of the convex parts 40a and the concave parts 40b in the preamble pattern are not limited to the example described above and the length of the convex parts 40a and the length of the concave parts 40b can be set at respectively different lengths. Also, since the lengths along the direction of rotation of the protruding end surfaces of the convex parts 40a formed in the preamble pattern region Ap are equal at positions with the same radius, the diameters of inscribed circles that contact (two-point contact) both ends in the direction of rotation of a protruding end surface of the convex parts 40a are equal at positions with the same radius. In addition, on the magnetic disk 10, out of the inscribed circles on the protruding end surfaces of the convex parts 40a formed in the preamble pattern regions Ap across the entire region from the inner periphery region Ai to the outer periphery region Ao, a diameter L5 of the inscribed circle Qp1 of the protruding end surfaces of the convex parts 40a formed in the outer periphery region Ao is the largest diameter.

Also, the address pattern formed in each address pattern region Aa is a servo pattern formed corresponding to the address data and the like showing the track number and the like of the track to which the magnetic head 3 is being made on-track, and as shown in FIG. 7, the lengths of the protruding end surfaces of the convex parts 40a along the direction of rotation and the lengths of the base surfaces of the concave parts 40b along the direction of rotation are set corresponding to such address data. Here, as one example, the minimum length out of the lengths along the radial direction of the protruding end surfaces of the convex parts 40a formed in the address pattern region Aa is set so as to be equal to the sum of the length L3 along the radial direction of the protruding end surfaces of the convex parts 40a and the length L4 along the radial direction of the base surfaces of the concave parts 40b in the data track pattern 40t (i.e., equal to the track pitch). Also, on the magnetic disk 10, the concave parts 40b are formed inside each servo pattern region As so that the inscribed circle Qa1 with the largest diameter (the inscribed circle with the diameter L1 shown in FIG. 7) out of the inscribed circles on the protruding end surfaces of the convex parts 40a formed in the address pattern regions Aa is the inscribed circle with the largest diameter out of the inscribed circles on the protruding end surfaces of all of the convex parts 40a inside the servo pattern region As.

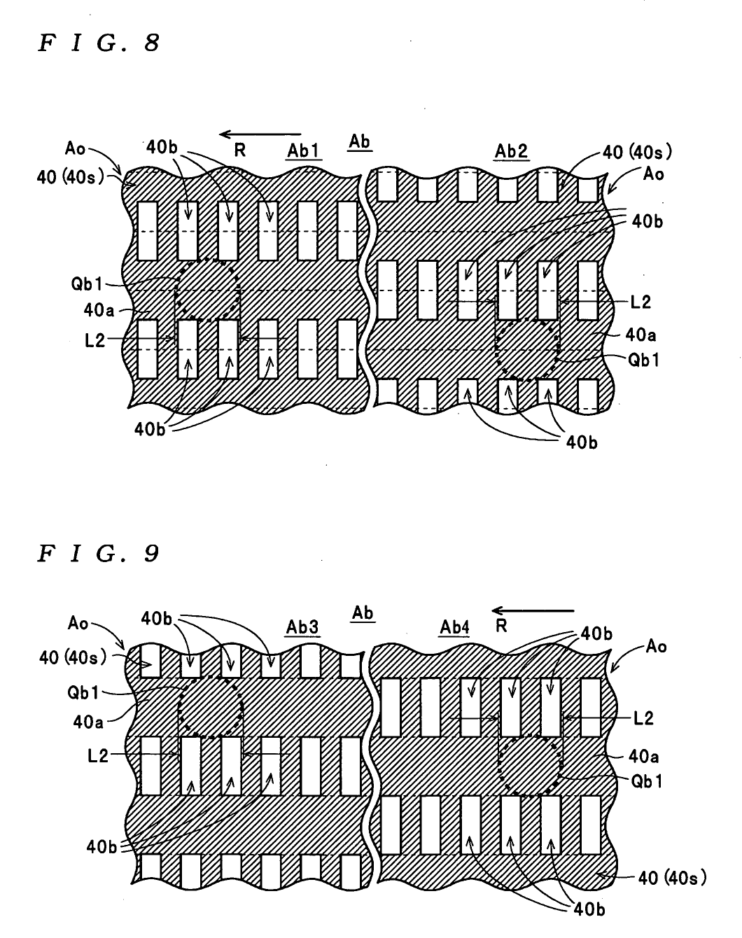

Also, as shown in FIG. 3, each burst pattern region Ab includes first to fourth burst pattern regions Ab1 to Ab4 and the non-servo signal regions Axb. In this case, the burst patterns formed in the first to fourth burst regions Ab1 to Ab4 are servo patterns for detecting positions in order to make the magnetic head 3 on-track to a desired track, and as shown in FIGS. 8 and 9, by forming a plurality of concave parts 40b along the direction of rotation of the magnetic disk 10, regions where the convex parts 40a and the concave parts 40b are alternately disposed in the direction of rotation and regions where the convex parts 40a are continuous in the direction of rotation are formed. Here, on the magnetic disk 10, burst signal unit parts (a plurality of rectangular regions aligned along the direction of rotation inside the burst region Ab) in the burst pattern region Ab are constructed of the concave parts 40b. Accordingly, compared to a magnetic disk where the burst signal parts are constructed of the convex parts 40a, the surface area of the magnetic layer 14 inside the burst pattern region Ab can be sufficiently increased. As a result, the signal level of the output signal outputted from the magnetic head 3 when the burst pattern region Ab passes below the magnetic head 3 can be sufficiently increased.

Here, as one example, the length along the direction of rotation of the protruding end surfaces of the convex parts 40a between the concave parts 40b aligned along the direction of rotation in the first to fourth burst regions Ab1 to Ab4 in the burst pattern region Ab is set equal to the length along the direction of rotation of the protruding end surfaces of the convex parts 40a formed in the preamble pattern region Ap at positions with the same radius. Also, as one example, the length along the direction of rotation of the base surfaces of the concave parts 40b formed in the burst pattern region Ab is set equal to the length along the direction of rotation of the base surfaces of the concave parts 40b formed in the preamble pattern region Ap at positions with the same radius. In addition, the minimum length along the radial direction of the protruding end surfaces of the convex parts 40a between the concave parts 40b aligned in the radial direction in the first to fourth burst regions Ab1 to Ab4 in the burst pattern region Ab is set equal to the minimum length along the radial direction of the protruding end surfaces of the convex parts 40a formed in the address pattern region Aa and equal to the sum of the length L3 along the radial direction of the protruding end surfaces of the convex parts 40a and the length L4 along the radial direction of the base surfaces of the concave parts 40b in the data track pattern 40t (that is, equal to the track pitch).

Also, as shown in FIG. 3, the rows of concave parts 40b formed in each burst pattern region Ab (the rows aligned in the direction of rotation) are displaced by one track pitch in the radial direction between the first burst region Ab1 and the second burst region Ab2 and by one track pitch in the radial direction between the third burst region Ab3 and the fourth burst region Ab4. In addition, a burst pattern composed of a pair of the concave/convex pattern 40 inside the first burst region Ab1 and the concave/convex pattern 40 inside the second burst region Ab2 and a burst pattern composed of a pair of the concave/convex pattern 40 inside the third burst region Ab3 and the concave/convex pattern 40 inside the fourth burst region Ab4 are respectively displaced by half a track pitch in the radial direction. Here, as shown in FIGS. 8 and 9, the inscribed circle Qb1 with the largest diameter out of the inscribed circles on the protruding end surfaces on the convex parts 40a formed inside the first to fourth burst regions Ab1 to Ab4 in each burst pattern region Ab contacts (four-point contact) four concave parts 40b in the rows of concave parts 40b aligned along the direction of rotation of the magnetic disk 10. Note that the diameter L2 of the inscribed circle Qb1 is smaller than the diameter L1 of the inscribed circle Qa1 inside the address pattern region Aa described above.

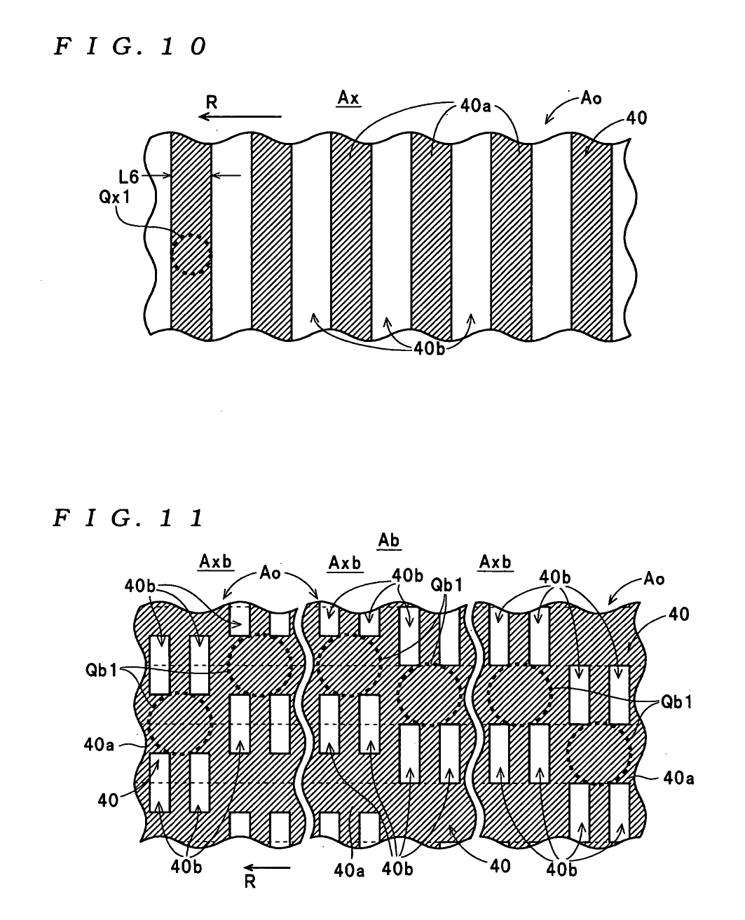

In addition, as shown in FIG. 3, the non-servo signal regions Ax that are one example of “second function regions” for the present invention are formed between one data recording region At and the preamble pattern region Ap, between the preamble pattern region Ap and the address pattern region Aa, between the address pattern region Aa and the burst pattern region Ab, and between the burst pattern region Ab and another data recording region At. In such non-servo signal regions Ax, patterns (examples of “concave/convex patterns of a different type to the concave/convex patterns of the first function regions” for the present invention) of a different type to the various patterns formed in the preamble pattern region Ap, the address pattern region Aa, and the burst pattern region Ab (the first to fourth burst regions Ab1 to Ab4) described above are formed. More specifically, as shown in FIG. 10, in the non-servo signal regions Ax, belt-shaped convex parts 40a that extend in the radial direction of the magnetic disk 10 (the up-down direction in FIG. 10) are formed with concave parts 40b in between along the direction of rotation of the magnetic disk 10 (the direction of the arrow R).

Here, as one example, the length along the direction of rotation of the protruding end surfaces of the convex parts 40a formed in the non-servo signal regions Ax and the length along the direction of rotation of the base surfaces of the concave parts 40b are set respectively equal for positions with an equal radius where the distance from the center O is equal and so as to increase from the inner periphery region Ai toward the outer periphery region Ao. Accordingly, inscribed circles that contact (two-point contact) both ends in the direction of rotation of the protruding end surfaces of the convex parts 40a formed in the non-servo signal regions Ax have the same diameter at positions with the same radius and an inscribed circle Qx1 (diameter L6) on a protruding end surface of a convex part 40a in the outer periphery region Ao is the inscribed circle with the largest diameter out of the inscribed circles of the convex parts 40a inside the non-servo signal regions Ax. Also, on the magnetic disk 10, the length along the direction of rotation of the protruding end surfaces of the convex parts 40a and the length along the direction of rotation of the base surfaces of the concave parts 40b formed in the outer periphery region Ao of the non-servo signal regions Ax are set equal to the length L3 of the protruding end surfaces of the convex parts 40a and the length L4 of the base surfaces of the concave parts 40b in the data recording regions At. Note that the lengths along the direction of rotation of the convex parts 40a and the concave parts 40b in the non-servo signal regions Ax are not limited to the example described above, and the length of the convex parts 40a and the length of the concave parts 40b can be set at respectively different lengths. Also, the lengths can be set at different lengths to the length L3 of the convex parts 40a and the length L4 of the concave parts 40b formed in the data recording regions At.

The concave/convex pattern 40 formed in the non-servo signal regions Ax is a dummy pattern for avoiding deterioration in surface smoothness of the magnetic disk 10 during manufacturing, and although the reading of a magnetic signal by the magnetic head 3 and the detection process for the servo data carried out by the detecting unit 4 are performed during the recording and reproducing of data on the magnetic disk 10, the control unit 6 distinguishes the data corresponding to the concave/convex patterns 40 formed in the non-servo signal regions Ax as different data to the servo data for a tracking servo. Accordingly, the lengths of the convex parts 40a and the concave parts 40b formed inside the non-servo signal regions Ax can be freely set within a range where favorable surface smoothness can be achieved for the magnetic disk 10 without being affected by the lengths of the other patterns. The shapes of the convex parts 40a and the concave parts 40b can also be set freely.

In addition, as shown in FIG. 3, the non-servo signal regions Axb are respectively formed between the first burst region Ab1 and the second burst region Ab2, between the second burst region Ab2 and the third burst region Ab3, and between the third burst region Ab3 and the fourth burst region Ab4 in the burst pattern region Ab. In the same way as the non-servo signal regions Ax described above, the non-servo signal regions Axb are regions in which dummy patterns for avoiding deterioration in the surface smoothness of the magnetic disk 10 during manufacturing are formed, and as shown in FIG. 11, similar patterns (the same shapes) to the burst patterns formed in the respective regions from the first burst region Ab1 to the fourth burst region Ab4 are formed as dummy patterns. More specifically, in the non-servo signal region Axb between the first burst region Ab1 and the second burst region Ab2 (the non-servo signal region Axb on the left side in FIG. 11), the same type of burst pattern (the convex parts 40a and the concave parts 40b) as the first burst region Ab1 is formed on the first burst region Ab1 side of the non-servo signal region Axb in the direction of rotation, and the same type of burst pattern (the convex parts 40a and the concave parts 40b) as the second burst region Ab2 is formed on the second burst region Ab2 side of the non-servo signal region Axb in the direction of rotation.

In the same way, in the non-servo signal region Axb between the second burst region Ab2 and the third burst region Ab3 (the non-servo signal region Axb in the center in FIG. 11), the same type of burst pattern as the second burst region Ab2 is formed on the second burst region Ab2 side in the direction of rotation, and the same type of burst pattern as the third burst region Ab3 is formed on the third burst region Ab3 side in the direction of rotation. Also, in the non-servo signal region Axb between the third burst region Ab3 and the fourth burst region Ab4 (the non-servo signal region Axb on the right side in FIG. 11), the same type of burst pattern as the third burst region Ab3 is formed on the third burst region Ab3 side in the direction of rotation, and the same type of burst pattern as the fourth burst region Ab4 is formed on the fourth burst region Ab4 side in the direction of rotation. Accordingly, in the burst pattern region Ab, the first to fourth burst regions Ab1 to Ab4 appear to be continuous with no non-servo signal regions Axb being present. However, although magnetic signals are read by the magnetic head 3 from the non-servo signal region Axb during the recording and reproducing of data on the magnetic disk 10, the control unit 6 distinguishes the data corresponding to the concave/convex pattern 40 formed in the non-servo signal region Axb as different data to the servo data for a tracking servo.

Here, as shown in FIG. 11, in the same way as the inscribed circle Qb1 with the largest diameter out of the inscribed circles on the protruding end surfaces of the convex parts 40a formed inside the first to fourth burst regions Ab1 to Ab4, the inscribed circle Qb1 with the largest diameter out of the inscribed circles on the protruding end surfaces of the convex parts 40a formed inside the non-servo signal region Axb contacts (four-point contact) four concave parts 40b in the rows of concave parts 40b aligned along the direction of rotation. The diameter L2 of the inscribed circle Qb1 is also smaller than the diameter L1 of the inscribed circle Qa1 inside the address pattern region Aa described above. Note that the lengths and shapes of the convex parts 40a and the concave parts 40b formed inside the non-servo signal region Axb are not affected by the lengths of the other patterns and can be freely set within a range that produces favorable surface smoothness for the magnetic disk 10.

On the magnetic disk 10, as described above, the inscribed circle Qa1 with the largest diameter (the diameter L1) out of the inscribed circles on the protruding end surfaces of the convex parts 40a formed in the address pattern region Aa is the inscribed circle with the largest diameter out of the inscribed circles on the protruding end surfaces of the convex parts 40a formed inside the servo pattern region As. In other words, on the magnetic disk 10, the concave parts 40b are formed in the servo pattern region As so that convex parts 40a with protruding end surfaces that can have an inscribed circle with a larger diameter than the diameter L1 of the inscribed circle Qa1 described above are not present in the servo pattern region As. Also, on the magnetic disk 10, the length L3 along the radial direction (the redial direction of the magnetic disk 10) of the protruding end surfaces of the convex parts 40a formed in the data recording region At is sufficiently shorter than the diameter L1 of the inscribed circle Qa1 described above. In other words, on the magnetic disk 10, the concave parts 40b are formed in the data recording region At so that convex parts 40a with protruding end surfaces that can have an inscribed circle with a larger diameter than the diameter L1 of the inscribed circle Qa1 described above are not present in the data recording region At.

Next, the method of manufacturing the magnetic disk 10 will be described.

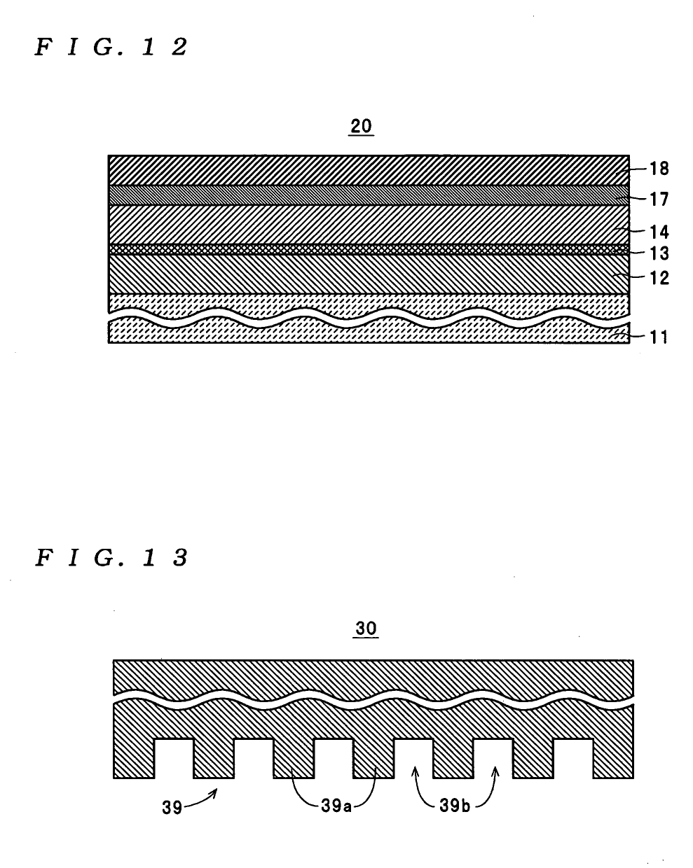

When manufacturing the magnetic disk 10 described above, a preform 20 shown in FIG. 12 and a stamper 30 shown in FIG. 13 are used. Here, as shown in FIG. 12, the preform 20 is constructed by forming the soft magnetic layer 12, the intermediate layer 13, and the magnetic layer 14 in that order on the glass substrate 11 and a mask layer 17 and a resin layer (resist layer) 18 with a thickness of around 80nm are formed on the magnetic layer 14. On the other hand, the stamper 30 is one example of a stamper for manufacturing a magnetic recording medium according to the present invention and as shown in FIG. 13 is constructed by forming a concave/convex pattern 39 that can form a concave/convex pattern 41 for forming the concave/convex pattern 40 (the data track pattern 40t and the servo pattern 40s) on the magnetic disk 10 so as to be capable of manufacturing the magnetic disk 10 by an imprinting method. In this case, the concave/convex pattern 39 of the stamper 30 is formed so that convex parts 39a correspond to the concave parts 40b in the concave/convex pattern 40 of the magnetic disk 10 and concave parts 39b correspond to the convex parts 40a in the concave/convex pattern 40.

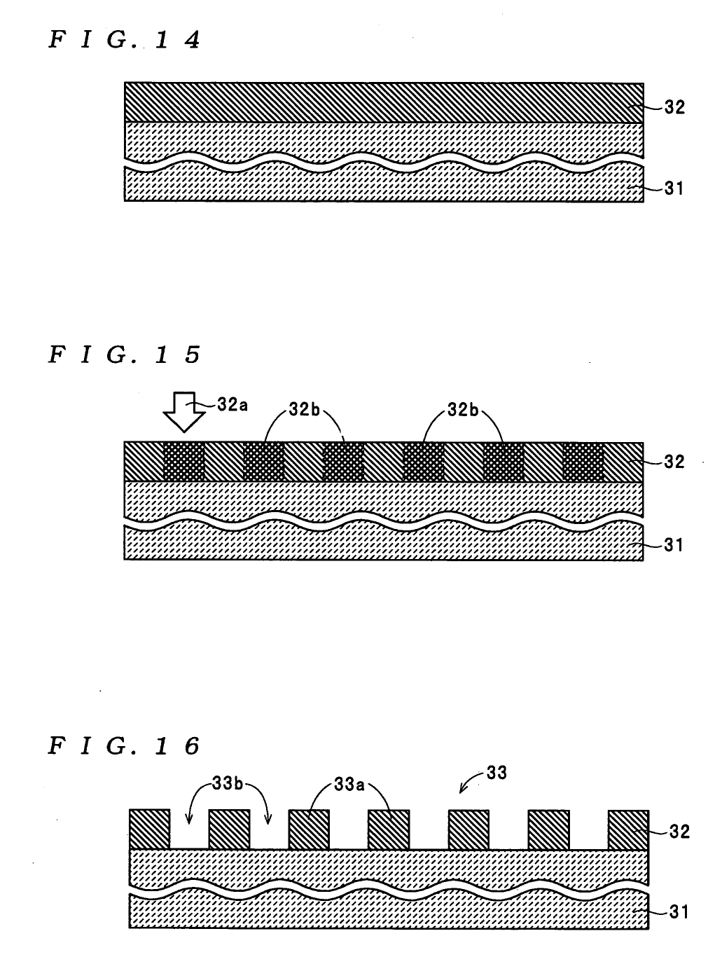

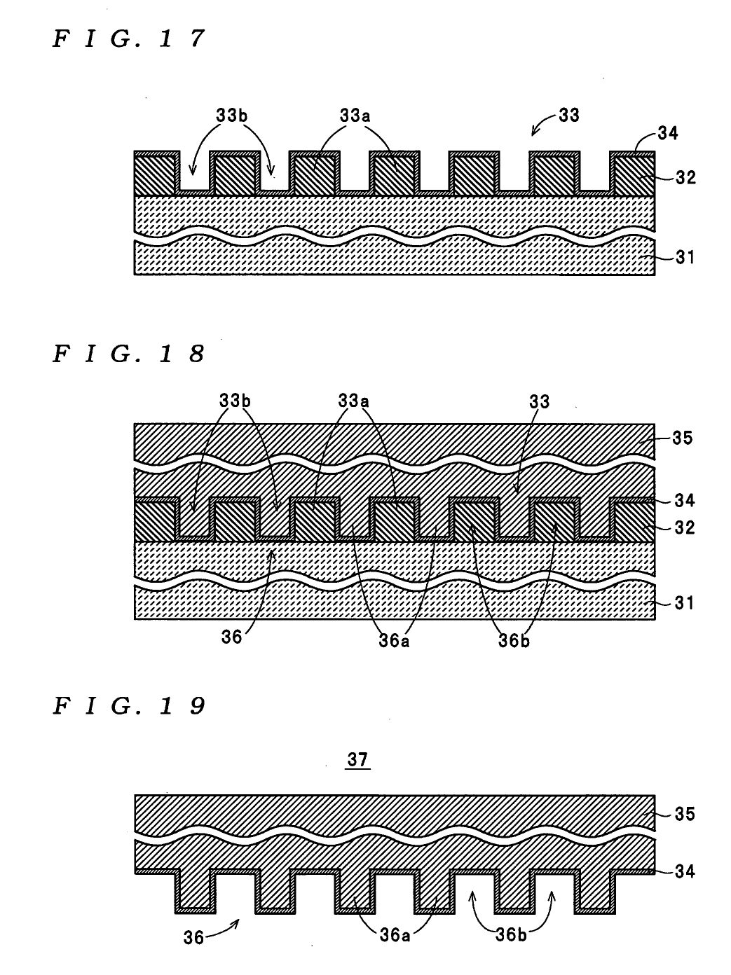

When manufacturing the stamper 30, as shown in FIG. 14, first a positive-type resist, for example, is spin coated on a glass substrate 31 and baked to form a resist layer 32 with a thickness of around 150 nm on the glass substrate 31. Next, as shown in FIG. 15, an electron beam 32a is emitted at positions corresponding to the concave parts 39b of the stamper 30 (that is, positions corresponding to the convex parts 40a of the magnetic disk 10) to form a plurality of latent images 32b (track patterns and servo patterns) in the resist layer 32. Next, by developing the resist layer 32, as shown in FIG. 16, a concave/convex pattern 33 (convex parts 33a and concave parts 33b) composed of the resist layer 32 is formed on the glass substrate 31. After this, as shown in FIG. 17, a nickel layer 34 with a thickness of around 30 nm is formed by sputtering so as to cover the convex parts 33a and the concave parts 33b of the concave/convex pattern 33. Next, by carrying out a plating process that uses the nickel layer 34 as an electrode, as shown in FIG. 18, a nickel layer 35 is formed on the nickel layer 34. At this time, the concave/convex pattern 33 formed by the resist layer 32 is transferred to the laminated body composed of the nickel layers 34 and 35, thereby forming a convex/concave pattern 36 in the laminated body composed of the nickel layers 34 and 35 where concave parts 36b are formed at positions of the convex parts 33a in the concave/convex pattern 33 and convex parts 36a are formed at the positions of the concave parts 33b.

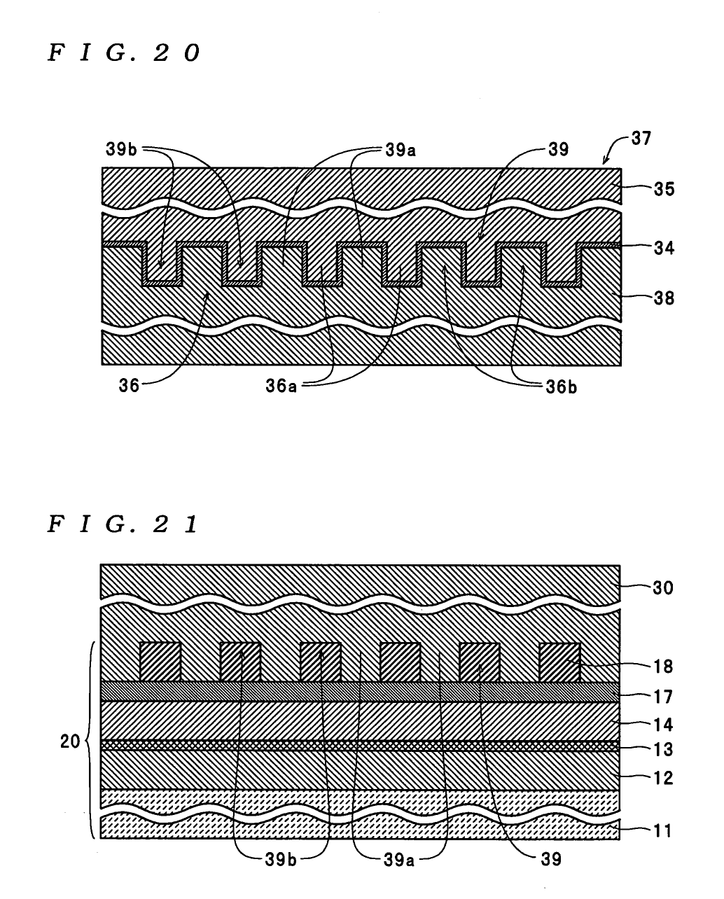

Next, by soaking the laminated body composed of the glass substrate 31, the resist layer 32, and the nickel layers 34 and 35 in a resist remover, the resist layer 32 present between the glass substrate 31 and the laminated body composed of the nickel layers 34 and 35 is removed. By doing so, as shown in FIG. 19, the laminated body composed of the nickel layers 34 and 35 is separated from the glass substrate 31 to complete a stamper 37. Next, the stamper 37 is used as a master stamper to fabricate the stamper 30 (a “mother stamper”). More specifically, first by carrying out a surface treatment on the stamper 37, an oxide film is formed on the surface of the stamper 37 on which the concave/convex pattern 36 is formed. After this, as shown in FIG. 20, a nickel layer 38 is formed by carrying out a plating process on the stamper 37 on which the formation of the oxide layer has been completed. At this time, the concave/convex pattern 36 of the stamper 37 is transferred to the nickel layer 38 to form the concave/convex pattern 39 in the nickel layer 38 by forming the concave parts 39b at the positions of the convex parts 36a and the convex parts 39a at the positions of the concave parts 36b. Next, after the stamper 37 has been separated from the nickel layer 38, the rear surface (the rear surface with respect to the surface on which the concave/convex pattern 39 is formed) of the nickel layer 38 is subjected to a polishing process to smooth the surface, thereby completing the stamper 30 as shown in FIG. 13.

On the other hand, when manufacturing the preform 20, first after the soft magnetic layer 12 has been formed on the glass substrate 11 by sputtering CoZrNb alloy on the glass substrate 11, the intermediate layer 13 is formed by sputtering an intermediate layer forming material on the soft magnetic layer 12. Next, by sputtering CoCrPt alloy on the intermediate layer 13, the magnetic layer 14 is formed with a thickness of around 15 nm. After this, the mask layer 17 is formed on the magnetic layer 14, and the resin layer 18 is formed with a thickness of around 80 nm on the mask layer 17 by spin coating a resist, for example. By doing so, the preform 20 is completed.

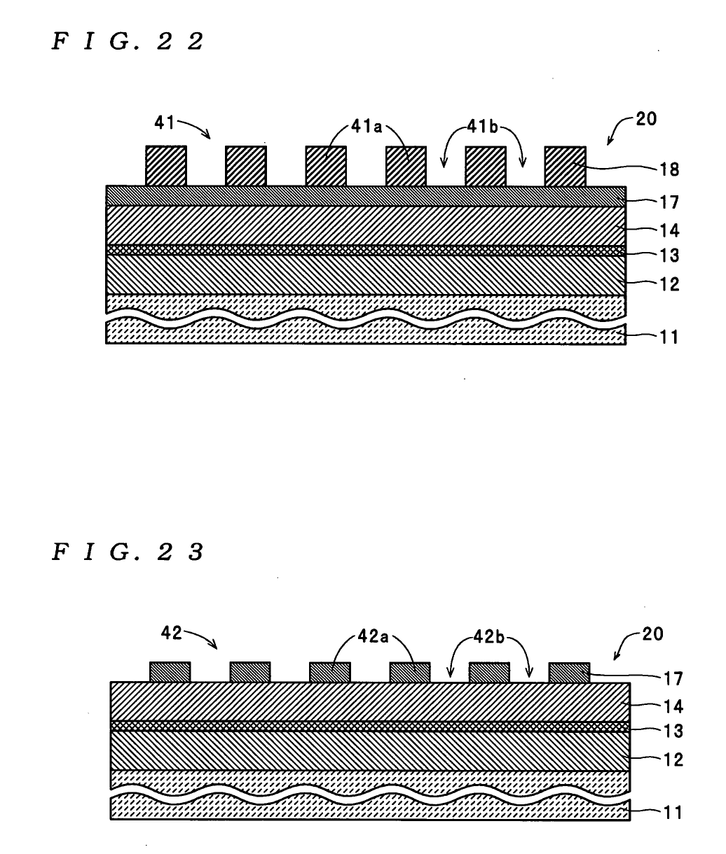

Next, as shown in FIG. 21, the concave/convex pattern 39 of the stamper 30 is transferred to the resin layer 18 of the preform 20 by imprinting. More specifically, by pressing the surface of the stamper 30 on which the concave/convex pattern 39 is formed onto the resin layer 18 of the preform 20, the convex parts 39a of the concave/convex pattern 39 are pressed into the resin layer 18 of the preform 20. When doing so, the resist (resin layer 18) at positions where the convex parts 39a are pressed in moves inside the concave parts 39b of the concave/convex pattern 39. After doing so, the preform 20 is separated from the stamper 30 and by carrying out an oxygen plasma process to remove resin (not shown) remaining on the base surfaces, as shown in FIG. 22, a concave/convex pattern 41 composed of the resin layer 18 is formed on the mask layer 17 of the preform 20. Here, the height of the convex parts 41a in the concave/convex pattern 41 (or the depth of the concave parts 41b) is around 130 nm.

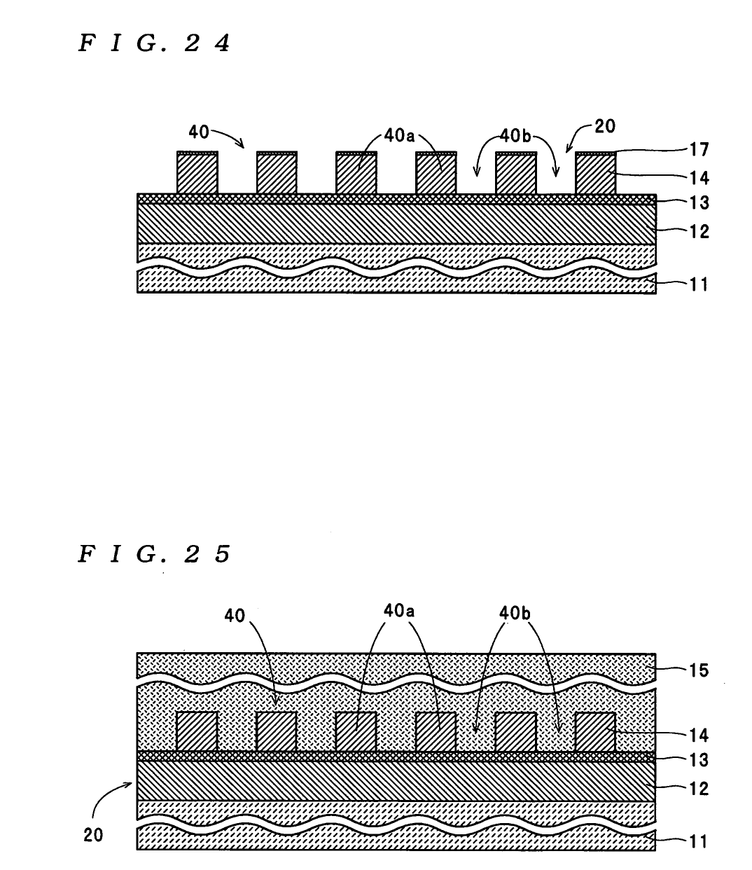

Next, by carrying out an etching process using the concave/convex pattern 41 (the resin layer 18) described above as a mask, the mask layer 17 exposed from the mask (the convex parts 41a) at the base parts of the concave parts 41b in the concave/convex pattern 41 is etched as shown in FIG. 23 to form a concave/convex pattern 42 including convex parts 42a and concave parts 42b in the mask layer 17 of the preform 20. After this, by carrying out an etching process with the concave/convex pattern 42 (the mask layer 17) as a mask, the magnetic layer 14 exposed from the mask (the convex parts 42a) at the base parts of the concave parts 42b of the concave/convex pattern 42 is etched as shown in FIG. 24 to form the concave/convex pattern 40 including the convex parts 40a and the concave parts 40b in the magnetic layer 14 of the preform 20. By doing so, the data track pattern 40t and the servo pattern 40s (the concave/convex pattern 40) are formed on the intermediate layer 13. Next, by carrying out a selective etching process on the mask layer 17 remaining on the convex parts 40a, the remaining mask layer 17 is completely removed to expose the protruding end surfaces of the convex parts 40a.

Next, as shown in FIG. 25, SiO₂ is sputtered as the non-magnetic material 15. When doing so, a sufficient amount of non-magnetic material 15 is sputtered to completely fill the concave parts 40b with the non-magnetic material 15 and to form a layer of the non-magnetic material 15 with a thickness of around 60 nm, for example, on the convex parts 40a. After this, ion beam etching is carried out on the layer of the non-magnetic material 15 on the magnetic layer 14 (on the convex parts 40a and on the concave parts 40b). When doing so, the ion beam etching continues until the protruding end surfaces of the convex parts 40a in the address pattern region Aa in the outer periphery (the part that will later become the outer periphery region Ao of the magnetic disk 10) of the preform 20 are exposed from the non-magnetic material 15.

Here, on the magnetic disk 10 (the preform 20), as described above, in the entire servo pattern region As and the entire data recording region At, the concave parts 40b are formed so that convex parts 40a with protruding end surfaces that can have an inscribed circle with a larger diameter than the diameter L1 of the inscribed circle Qa1 described above are not present (i.e., so that convex parts 40a with excessively wide protruding end surfaces are not present), thereby forming the concave/convex patterns 40 (i.e., the servo pattern 40s and the data track pattern 40t) in the servo pattern region As and the data recording region At. Accordingly, unlike the conventional magnetic disk 10z, the protruding end surfaces (upper surfaces) of the convex parts 40a are exposed from the non-magnetic material 15 without thick residue being produced on the convex parts 40a inside the servo pattern region As and the convex parts 40a inside the data recording region At. By doing so, the ion beam etching is completed on the layer of the non-magnetic material 15 to smooth the surface of the preform 20. Next, after the protective layer 16 has been formed by forming a thin film of diamond-like carbon (DLC) by CVD so as to cover the surface of the preform 20, a Fomblin lubricant is applied to the surface of the protective layer 16 with an average thickness of around 2 nm, for example. By doing so, as shown in FIG. 4, the magnetic disk 10 is completed.

In the hard disk drive 1 equipped with the magnetic disk 10, as described above, during the recording and reproducing of data on the magnetic disk 10, the control unit 6 determines that the data corresponding to the concave/convex pattern 40 formed in the non-servo signal regions Ax and the non-servo signal regions Axb is different data to the servo data used for a tracking servo. More specifically, out of the data including the servo data outputted from the detecting unit 4, the control unit 6 controls the driver 5 based on the data corresponding to the concave/convex patterns 40 formed in the preamble pattern region Ap, the address pattern region Aa, and the burst pattern region Ab (aside from the non-servo signal region Axb) to move the actuator 3b and thereby make the magnetic head 3 on-track to the desired track. As a result, it is possible to carry out the recording and reproducing of data via the magnetic head 3 that is made on-track to the convex parts 40a (i.e., a data recording track) inside the data recording region At without such operation being affected by the presence of the concave/convex patterns 40 (i.e., the dummy patterns) formed in the non-servo signal regions Ax, Axb.

In this way, according to the magnetic disk 10 and the hard disk drive 1, by forming the concave parts 40b in the servo pattern region As so that the inscribed circle Qa1 with the largest diameter out of the inscribed circles on the protruding end surfaces of the convex parts 40a formed in the address pattern region Aa is the inscribed circle with the largest diameter out of the inscribed circles on the protruding end surfaces of the convex parts 40a formed in the servo pattern region As, since convex parts 40a with wide protruding end surfaces that can have an inscribed circle with a larger diameter than the diameter L1 of the inscribed circle Qa1 described above are not present in the servo pattern region As, when the layer of the non-magnetic material 15 formed so as to cover the concave/convex pattern 40 inside the servo pattern region As is etched, a situation where thick residue is produced on the convex parts 40a can be avoided. By doing so, it is possible to provide a magnetic disk 10, which has favorable smoothness inside the servo pattern region As and from which servo data can be reliably read, and also a hard disk drive 1 equipped with such magnetic disk 10.

Also, according to the magnetic disk 10 and the hard disk drive 1, by forming the data recording tracks (the convex parts 40a) in the data recording region At so that the length L3 along the radial direction is equal to or smaller than the diameter of the inscribed circle with the largest diameter out of the inscribed circles on the protruding end surfaces of the convex parts 40a formed in the servo pattern region As (in this example, the diameter L1 of the inscribed circle Qa1 on the protruding end surfaces of the convex parts 40a formed in the address pattern region Aa), it is possible to avoid a situation where thick residue is produced on the convex parts 40a inside the data recording region At. Accordingly, it is possible to provide a magnetic disk 10, which has favorable smoothness inside both the servo pattern region As and the data recording region At (that is, across the entire magnetic disk 10) and which is capable of stabilized recording and reproducing, and also a hard disk drive 1 equipped with such magnetic disk 10.

In addition, according to the magnetic disk 10 and the hard disk drive 1, by constructing the servo pattern regions As so as to include a plurality of types of the first function regions (in this example, the preamble pattern region Ap, the address pattern region Aa, and the burst pattern region Ab) in which control signals for tracking servo control are recorded by the concave/convex patterns 40 during manufacturing and second function regions (the non-servo signal regions Ax) in which concave/convex patterns 40 of a different type to the concave/convex patterns 40 of the first function regions are formed, unlike the conventional magnetic disk 10z where the entire region of the non-servo signal regions Axz, Axbz are composed of convex parts, it is possible to avoid a situation where residue remains inside the second function regions, and even if residue is produced, such residue can be made sufficiently thin.

Also, according to the magnetic disk 10 and the hard disk drive 1, by forming the concave parts 40b in the non-servo signal regions Ax so that the diameter of the inscribed circle with the largest diameter out of the inscribed circles on the protruding end surfaces of the convex parts 40a formed in the non-servo signal regions Ax is equal to or smaller than the diameter of the inscribed circle Qa1 with the largest diameter out of the inscribed circles on the protruding end surfaces of the convex parts 40a formed in the address pattern region Aa, it is possible to avoid a situation where thick residue is produced inside the non-servo signal regions Ax.

Also, according to the hard disk drive 1, by including the control unit 6 that carries out a tracking servo control process based on a predetermined signal read from a servo pattern region As on the magnetic disk 10, it is possible to carry out recording and reproducing of data via the magnetic head 3 that is made on-track to the convex parts 40a (a data recording track) inside the data recording region At without being affected by the presence of the concave/convex patterns 40 (dummy patterns) formed in the non-servo signal regions Ax (the second function regions).

Also, according to the stamper 30 described above, by forming the concave/convex pattern 39 including the convex parts 39a formed corresponding to the concave parts 40b of the concave/convex pattern 40 on the magnetic disk 10 and the concave parts 39b formed corresponding to the convex parts 40a of the concave/convex pattern 40, when imprinting is carried out on the preform 20, the concave/convex pattern 41 can be formed without convex parts 41a with wide protruding end surfaces (for example, convex parts 41a that are excessively long in the direction of rotation and excessively long in the radial direction) being present in the servo pattern regions As and the like. Accordingly, by etching the preform 20 using a mask (in this example, the concave/convex pattern 42) whose concave/convex positional relationship matches the concave/convex pattern 41, it is possible to avoid a situation where convex parts 40a with wide protruding end surfaces that can have inscribed circles with a larger diameter than the diameter L1 of the inscribed circle (in this example, the inscribed circle Qa1) with the largest diameter out of the inscribed circles on the protruding end surfaces of the convex parts 40a formed in the address pattern region Aa are formed inside the servo pattern regions As. Accordingly, when etching the layer of the non-magnetic material 15 formed so as to cover the concave/convex pattern 40, it is possible to avoid the situation where thick residue is produced on the convex parts 40a inside the servo pattern regions As. By doing so, it is possible to manufacture the magnetic disk 10 which has favorable smoothness and from which the servo data can be reliably read. Also, since excessively wide concave parts 39b corresponding to the protruding end surfaces of the convex parts 40a of the magnetic disk 10 are not present on the stamper 30, when the concave/convex pattern 39 is pressed onto the resin layer 18 of the preform 20, it is possible to avoid a situation where the height of the convex parts 41a is insufficient (i.e., the thickness of the resin mask is insufficient) due to an insufficient amount of resin material (the resin layer 18) moving inside the concave parts 39b. Accordingly, when etching the mask layer 17 using the concave/convex pattern 41 as a mask, it is possible to avoid a situation where the convex parts 41a disappear before the etching of the mask layer 17 is complete and therefore a concave/convex pattern 42 with sufficiently deep concave parts 42b can be formed on the magnetic layer 14. As a result, when the magnetic layer 14 is etched using the concave/convex pattern 42 as a mask, it is possible to form the concave/convex pattern 40 with sufficiently deep concave parts 40b on the intermediate layer 13.

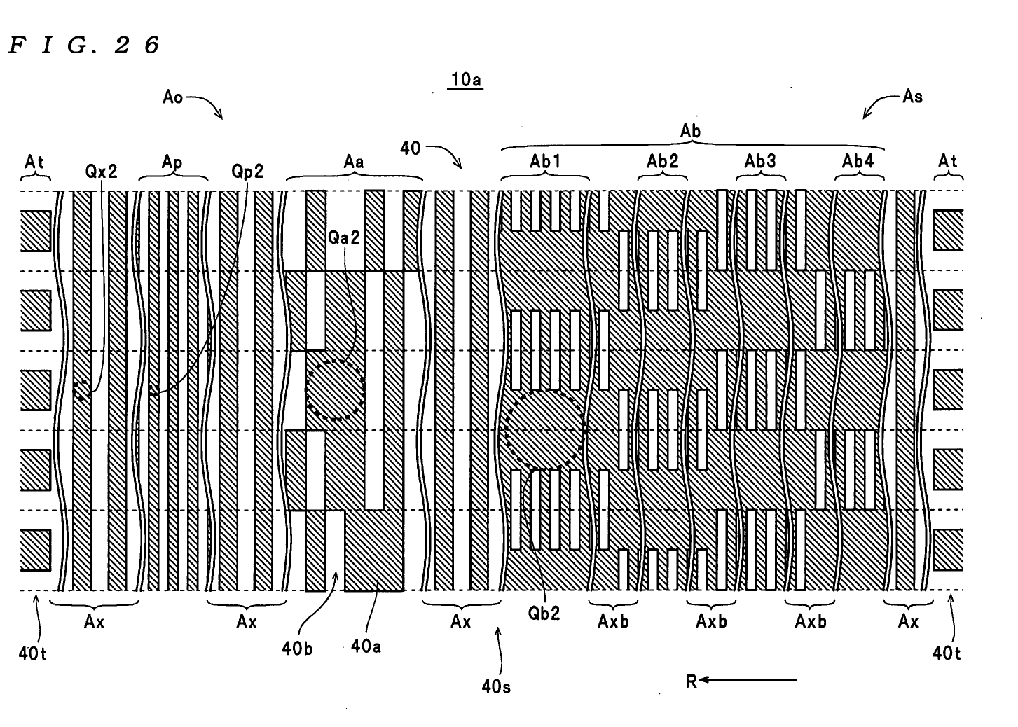

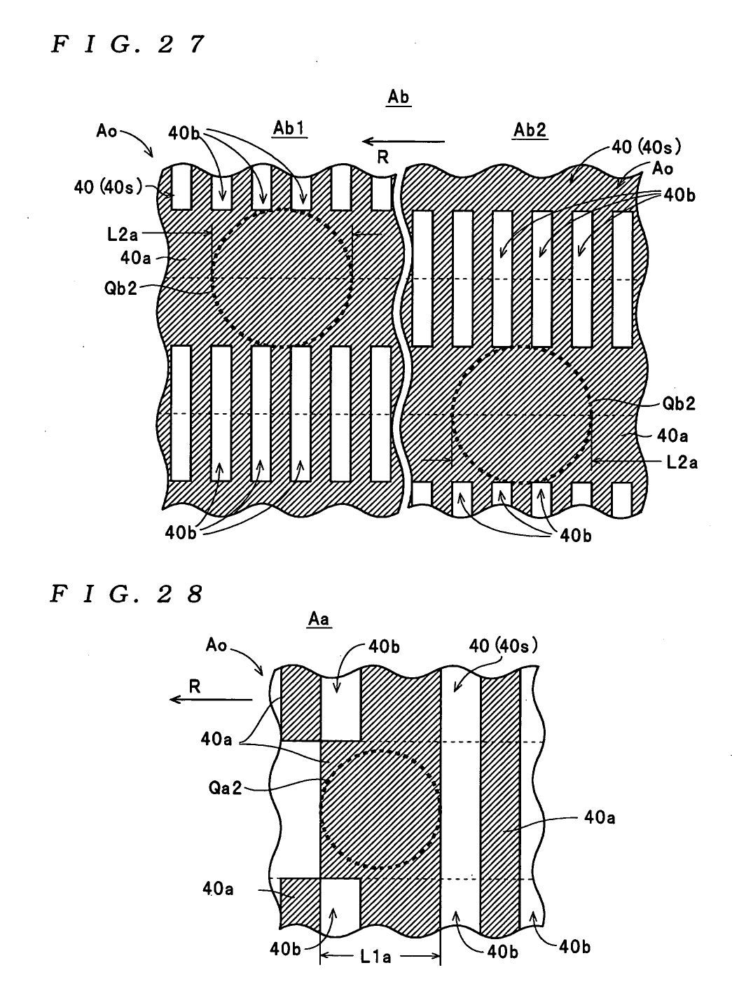

It should be noted that the present invention is not limited to the construction described above. For example, although on the magnetic disk 10 described above, the concave parts 40b are formed inside the servo pattern regions As so that the inscribed circle Qa1 with the largest diameter (in the above example, the diameter L1) out of the inscribed circles on the protruding end surfaces of the convex parts 40a formed inside the address pattern region Aa is the inscribed circle with the largest diameter out of the inscribed circles on the protruding end surfaces of all of the convex parts 40a formed inside the servo pattern regions As, the present invention is not limited to this and as one example, like a magnetic disk 10a shown in FIG. 26, the concave parts 40b can be formed inside the servo pattern regions As so that an inscribed circle Qb2 with the largest diameter out of the inscribed circles on the protruding end surfaces of the convex parts 40a formed inside the burst pattern regions Ab (the first to fourth burst regions Ab1 to Ab4) is the inscribed circle with the largest diameter out of the inscribed circles (in this example, the inscribed circles Qx2, Qp2, Qa2) on the protruding end surfaces of all of the convex parts 40a formed inside the servo pattern regions As. More specifically, on the magnetic disk 10a, as shown in FIG. 27, the inscribed circle Qb2 with the largest diameter out of the inscribed circles on the protruding end surfaces of the convex parts 40a formed in the burst pattern regions Ab contacts (four-point contact) four concave parts 40b in the rows of concave parts 40b aligned along the direction of rotation of the magnetic disk 10. Also, as shown in FIG. 28, the inscribed circle Qa2 with the largest diameter out of the inscribed circles on the protruding end surfaces of the convex parts 40a formed in the address pattern region Aa contacts (two-point contact) the concave parts 40b at both ends of the convex parts 40a in the direction of rotation, and the diameter L1a of the inscribed circle Qa2 is smaller than the diameter L2a of the inscribed circle Qb2 described above.

On the magnetic disk 10a, as described above, the inscribed circle Qb2 with the largest diameter (the diameter L2a) out of the inscribed circles on the protruding end surfaces of the convex parts 40a formed in the burst pattern regions Ab is the inscribed circle with the largest diameter out of the inscribed circles on the protruding end surfaces of the convex parts 40a formed inside the servo pattern regions As. In other words, on the magnetic disk 10a, the concave/convex patterns 40 are formed inside the servo pattern regions As so that convex parts 40a with protruding end surfaces that can have inscribed circles with a larger diameter than the diameter L2a of the inscribed circle Qb2 described above are not present. Also, on the magnetic disk 10a, the length L3 along the radial direction of the convex parts 40a in the data recording regions At is sufficiently shorter than the diameter L2a of the inscribed circle Qb2 described above. In other words, on the magnetic disk 10a, the concave/convex patterns 40 are formed in the data recording regions At so that convex parts 40a with protruding end surfaces that can have inscribed circles with a larger diameter than the diameter L2a of the inscribed circle Qb2 described above are not present.

According to the magnetic disk 10a, in the same way as the magnetic disk 10 described above, when the layer of the non-magnetic material 15 formed so as to cover the concave/convex pattern 40 inside the servo pattern regions As and the data recording regions At are etched, it is possible to avoid a situation where thick residue is produced on the convex parts 40a. By doing so, it is possible to provide the magnetic disk 10a that has favorable smoothness across the entire region and from which the servo data can be reliably read.

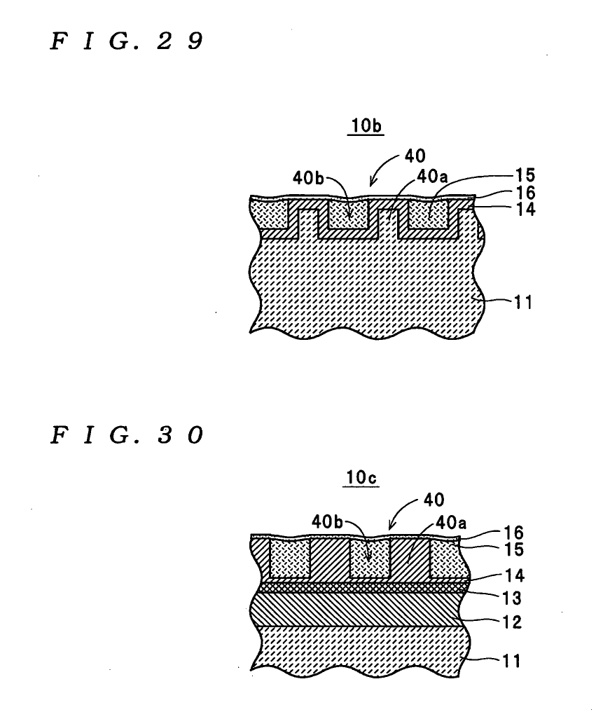

Also, on the magnetic disk 10 described above, although the entire regions from the protruding end parts to the base end parts of the convex parts 40a of the concave/convex pattern 40 are formed of the magnetic layer 14 (magnetic material), the convex parts that construct the concave/convex pattern of the present invention are not limited to this. More specifically, like a magnetic disk 10b shown in FIG. 29, for example, by forming a thin magnetic layer 14 so as to cover a concave/convex pattern formed in the glass substrate 11 (a concave/convex pattern where the convexes and concaves have the same positional relationship as the concave/convex pattern 40), it is possible to compose the concave/convex pattern 40 of a plurality of convex parts 40a whose surfaces are formed of magnetic material and a plurality of concave parts 40b whose base surfaces are also formed of the magnetic material. Also, like a magnetic disk 10c shown in FIG. 30, it is possible to construct a concave/convex pattern 40 where not only the convex parts 40a but also the base parts of the concave parts 40b are formed of the magnetic layer 14. As another example, it is also possible to construct the concave/convex pattern 40 (not shown) so as to include convex parts 40a where only the protruding end parts of the convex parts 40a in the concave/convex pattern 40 are formed of the magnetic layer 14 and the base end parts of the convex parts 40a are formed of a non-magnetic material or a soft magnetic material.

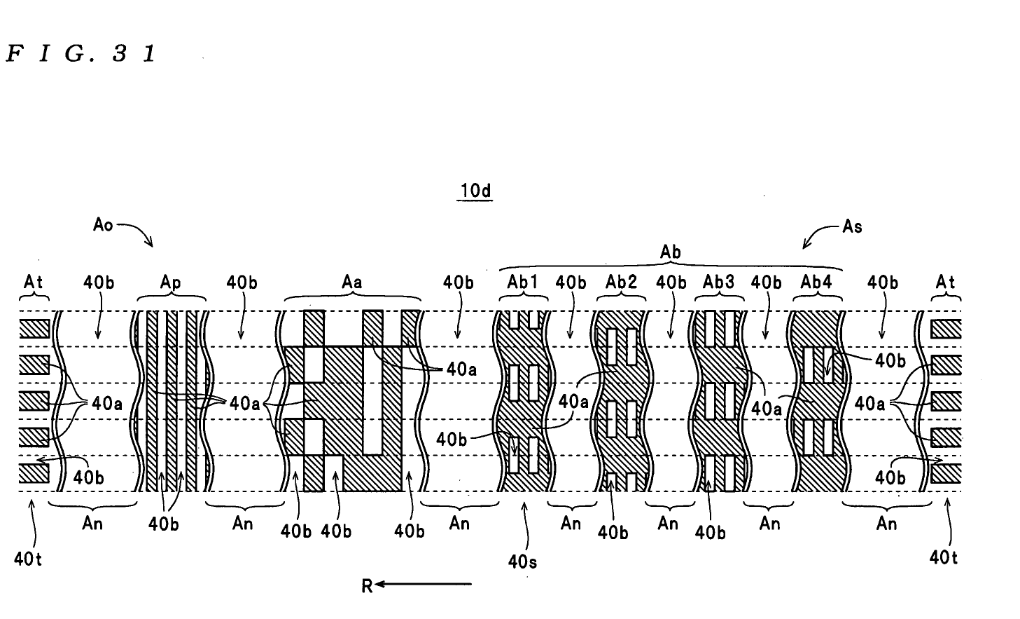

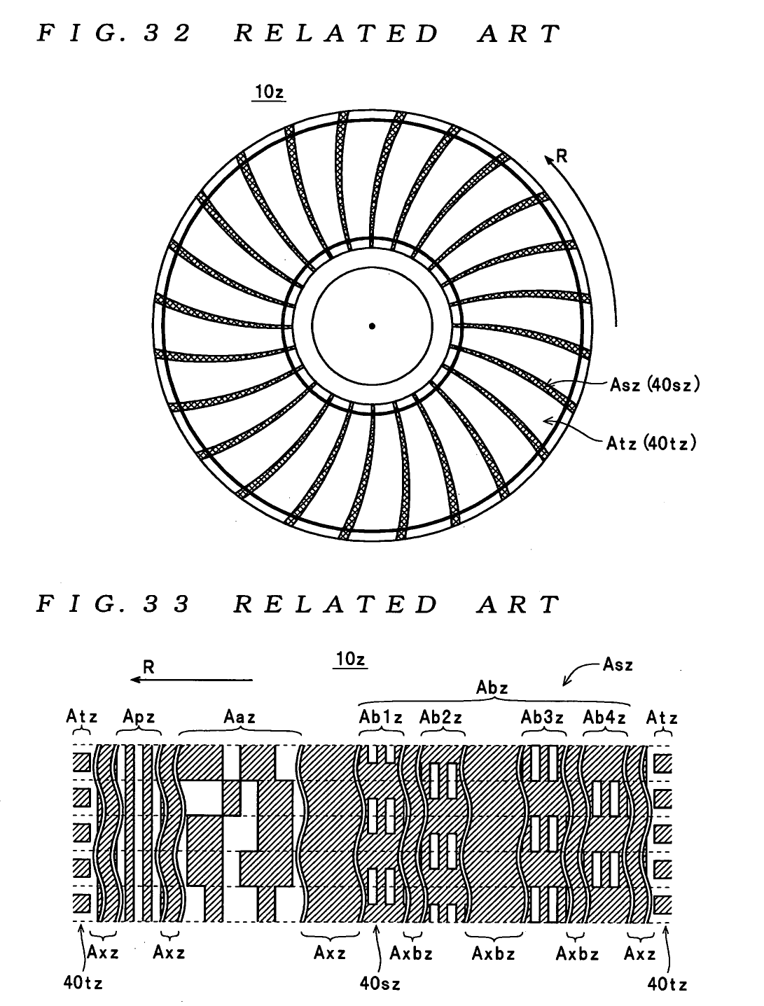

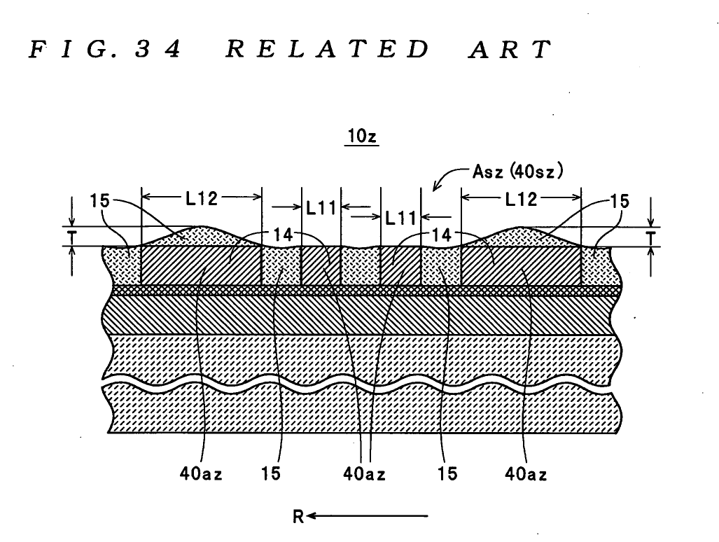

Also, although dummy patterns (the concave/convex patterns 40) are formed in the non-servo signal regions Ax and the non-servo signal regions Axb on the magnetic disk 10 described above, the present invention is not limited to this. For example, like the magnetic disk 10d shown in FIG. 31, it is possible to set the non-servo signal regions An (another example of the “second function region” of the present invention) between the data recording region At and the preamble pattern region Ap, between the preamble pattern region Ap and the address pattern region Aa, between the address pattern region Aa and the burst pattern region Ab, and between the burst pattern region Ab and the data recording region At, to also set non-servo signal regions An between the first burst region Ab1 and the second burst region Ab2, between the second burst region Ab2 and the third burst region Ab3, and between the third burst region Ab3 and the fourth burst region Ab4 in the burst pattern region Ab, and to construct the entire regions of the non-servo signal regions An of concave parts 40b.

On the magnetic disk 10d, like the magnetic disk 10 and the magnetic disk 10a described above, the concave/convex pattern 40 is formed so that at parts aside from the non-servo signal regions An, the inscribed circle with the largest diameter on the protruding end surfaces of one of the convex parts 40a formed in the address pattern region Aa and the convex parts 40a formed in the burst pattern region Ab (the first to fourth burst regions Ab1 to Ab4) is an inscribed circle with a largest diameter out of the inscribed circles on the protruding end surfaces of all of the convex parts 40a inside the servo pattern regions As. Also, on the magnetic disk 10d, the entire region of each non-servo signal region An is composed of the concave parts 40b. According to the magnetic disk 10d, since convex parts 40a for which there is the risk of residue being produced are not present inside the non-servo signal regions An and convex parts 40a (convex parts 40a for which concave parts 40b are not present within a predetermined range) whose protruding end surfaces are excessively wide are not present at parts aside from the non-servo signal regions An, when the layer of the non-magnetic material 15 formed so as to cover the concave/convex pattern 40 inside the servo pattern regions As is etched, it is possible to avoid a situation where thick residue is produced on the convex parts 40a across the entire range of the servo pattern regions As including the non-servo signal regions An. By doing so, it is possible to provide the magnetic disk 10d which has favorable smoothness inside the servo pattern region As and from which the servo data can be read reliably.

Also, although a concave/convex pattern 40 with belt-shaped convex parts 40a where the length along the direction of rotation in the outer periphery region Ao is equal to the length L3 along the radial direction of the convex parts 40a inside the data recording region At (i.e., equal to the track width of the data recording tracks) is formed inside the non-servo signal regions Ax as a dummy pattern on the magnetic disk 10 described above, the present invention is not limited to this. For example, like the non-servo signal regions Axb on the magnetic disk 10, a construction where the same type of patterns as the concave/convex patterns 40 formed inside regions adjacent to the non-servo signal regions Ax in the direction of rotation are formed as dummy patterns (i.e., a construction where no “second function regions” for the present invention are present inside the servo pattern region As) and a construction where concave/convex patterns 40 of arbitrary shapes that differ to the shapes of the concave/convex patterns 40 inside the “first function regions” for the present invention are formed as dummy patterns may be used. In addition, although concave/convex patterns 40 of the same type as the concave/convex patterns 40 inside the first to fourth burst regions Ab1 to Ab4 are formed as dummy patterns inside the non-servo signal regions Axb on the magnetic disk 10 described above, the present invention is not limited to this. For example, it is possible to use a construction where the same type of concave/convex patterns 40 as the concave/convex patterns 40 inside the non-servo signal regions Ax are formed inside the non-servo signal regions Axb or a construction where concave/convex patterns 40 of arbitrary shapes that differ to the shapes of the concave/convex patterns 40 inside the “first function regions” for the present invention are formed as dummy patterns. In addition, although the servo patterns 40s and the data track patterns 40t are formed on only one surface of the glass substrate 11 of the magnetic disks 10 to 10d described above, the magnetic recording medium according to the present invention is not limited to such and it is possible to form the servo patterns 40s and the data track patterns 40t on both front and rear surfaces of the glass substrate 11.

Also, although the magnetic disks 10, 10a, 10b, 10c, and 10d where a concave/convex pattern composed of a plurality of convex parts 40a and a plurality of concave parts 40b is formed in each servo pattern region As has been described for the above embodiment, the present invention is not limited to such, and it is also possible to use a magnetic disk (not shown) where every recess around a plurality of convex parts 40a is made continuous to form a single concave part in a servo pattern region As.

1. A magnetic recording medium where a servo pattern is formed in a servo pattern region on at least one surface of a substrate by a concave/convex pattern including a plurality of convex parts, at least protruding end parts of which are formed of magnetic material, and at least one concave part, and the servo pattern region includes an address pattern region and a burst pattern region,
wherein the at least one concave part is formed in the servo pattern region so that a larger of an inscribed circle with a largest diameter out of inscribed circles on protruding end surfaces of the convex parts formed in the address pattern region and an inscribed circle with a largest diameter out of inscribed circles on protruding end surfaces of the convex parts formed in the burst pattern region is an inscribed circle with a largest diameter out of inscribed circles on protruding end surfaces of the convex parts formed in the servo pattern region.

2. A magnetic recording medium according to claim 1, wherein a plurality of data recording tracks are formed in a data recording region on the at least one surface of the substrate by the convex parts, at least protruding end parts of which are formed of the magnetic material, the data recording tracks being formed so that a length along a the radial direction is equal to or smaller than the diameter of the larger of the inscribed circles.

3. A magnetic recording medium where a servo pattern is formed in a servo pattern region on at least one surface of a substrate by a concave/convex pattern including a plurality of convex parts, at least protruding end parts of which are formed of magnetic material, and at least one concave part,
wherein the servo pattern region includes a plurality of types of first function regions in which a control signal for tracking servo control is recorded by the concave/convex pattern during manufacturing and a second function region where a concave/convex pattern of a different type to the concave/convex patterns of the first function regions is formed.

4. A magnetic recording medium according to claim 3, wherein the servo pattern region includes an address pattern region and a burst pattern region as types in the plurality of types of first function regions,
wherein the at least one concave part is formed in the second function region so that a diameter of an inscribed circle with a largest diameter out of inscribed circles on protruding end surfaces on convex parts formed in the second function region is equal to or smaller than a diameter of a larger of an inscribed circle with a largest diameter out of inscribed circles on protruding end surfaces of the convex parts formed in the address pattern region and an inscribed circle with a largest diameter out of inscribed circles on protruding end surfaces of the convex parts formed in the burst pattern region.

5. A magnetic recording medium where a servo pattern is formed in a servo pattern region on at least one surface of a substrate by a concave/convex pattern including a plurality of convex parts, at least protruding end parts of which are formed of magnetic material, and at least one concave part,
wherein the servo pattern region includes a plurality of types of first function regions in which a control signal for tracking servo control is recorded by a concave/convex pattern during manufacturing and a second function region formed entirely of the at least one concave part.

6. A recording/reproducing apparatus comprising:
a magnetic recording medium according to claim 1; and
a control unit that carries out a tracking servo control process based on a predetermined signal read from the servo pattern region of the magnetic recording medium.

7. A recording/reproducing apparatus comprising:
a magnetic recording medium according to claim 3; and
a control unit that carries out a tracking servo control process based on a predetermined signal read from the first function regions of the magnetic recording medium.

8. A recording/reproducing apparatus comprising:
a magnetic recording medium according to claim 5; and
a control unit that carries out a tracking servo control process based on a predetermined signal read from the first function regions of the magnetic recording medium.

9. A stamper for manufacturing a magnetic recording medium on which is formed a concave/convex pattern including at least one convex part formed corresponding to the at least one concave part in the concave/convex pattern of a magnetic recording medium according to claim 1 and a plurality of concave parts formed corresponding to the respective convex parts in the concave/convex pattern of the magnetic recording medium.

10. A stamper for manufacturing a magnetic recording medium on which is formed a concave/convex pattern including at least one convex part formed corresponding to the at least one concave part in the concave/convex pattern of a magnetic recording medium according to claim 3 and a plurality of concave parts formed corresponding to the respective convex parts in the concave/convex pattern of the magnetic recording medium.

11. A stamper for manufacturing a magnetic recording medium on which is formed a concave/convex pattern including at least one convex part formed corresponding to the at least one concave part in the concave/convex pattern of a magnetic recording medium according to claim 5 and a plurality of concave parts formed corresponding to the respective convex parts in the concave/convex pattern of the magnetic recording medium.
